(19) United States
(12) Patent Application Publication
(10) Pub. No.: US 2023/0167871 A1
(43) Pub. Date: Jun. 1, 2023

(54) SHOCK ABSORBER

(71) Applicant: HITACHI ASTEMO, LTD., Ibaraki (JP)

(72) Inventor: Fumiyuki YAMAOKA, Ibaraki (JP)

(21) Appl. No.: 17/912,635

(22) PCT Filed: Feb. 22, 2021
(86) PCT No.: PCT/JP2021/006617

§ 371 Date: Sep. 19, 2022

(30) Foreign Application Priority Data
Mar. 27, 2020 (JP) 2020-058027

(51) Int. Cl. F16F 9/512

(52) U.S. Cl. CPC F16F 9/5126; F16F 9/185

(57) ABSTRACT

A shock absorber includes a cylinder-side member having an inner cylinder, a piston-side member having a piston and a piston rod that move relative to the inner cylinder, and a phase correction communication passage. The phase correction communication passage is provided between a bottom-side oil chamber, which is one side chamber, and a rod-side oil chamber, which is the other side chamber. That is, the phase correction communication passage is provided in the inner cylinder which is the cylinder-side member and communicates the bottom-side oil chamber and rod-side chamber with each other. By having a spiral conduit that advances in the axial direction while spiraling (orbiting) multiple times at the same diameter, the phase correction communication passage is configured as a second damping mechanism which generates a force (an axial force) that advances the phase of the damping force.

### TECHNICAL FIELD

The present disclosure relates to a shock absorber that reduces the vibration of a vehicle such as an automobile.

### BACKGROUND

Patent Document 1 describes a suspension control device that compensates for a response delay due to an actuator by controlling the actuator to have an unsprung acceleration whose phase advances by 90° with respect to a piston speed.

### PRIOR ART DOCUMENT

### Patent Document

Patent Document 1: Japanese Patent Laid-Open Publication No. 2005-255152

### SUMMARY OF THE INVENTION

### Problems to be Solved

For example, in the case of a shock absorber without an actuator in the related art, the flow of working fluid may not be controlled from the outside. Therefore, due to the phase delay of a damping force with respect to a piston speed, the force for damping a sprung mass (vehicle body) may decrease, and the force for exciting the sprung mass may increase. This may lead to a decrease in riding comfort with respect to a radio-frequency input.

An object of an embodiment of the present disclosure is to provide a shock absorber capable of suppressing a delay in damping force with respect to a radio-frequency vibration without controlling an actuator.

### Means to Solve the Problems

According to an embodiment of the present disclosure, a shock absorber includes: a cylinder-side member including a cylinder in which a working fluid is sealed; a piston-side member including a piston that divides an inside of the cylinder into one side chamber and another side chamber, and a piston rod that is connected to the piston and extends to an outside of the cylinder; a first communication passage provided on the piston-side member and communicating the one side chamber and the other side chamber; a second communication passage provided on the cylinder-side member and communicating the one side chamber and the other side chamber; and a first damping mechanism and a second damping mechanism provided in the first communication passage and the second communication passages, respectively. The second damping mechanism is a phase correction unit that advances a phase of a damping force by an inertial force of the working fluid in the second communication passage.

Further, according to an embodiment of the present disclosure, a shock absorber includes: a cylinder-side member including a cylinder in which a working fluid is sealed; a piston-side member including a piston that divides an inside of the cylinder into one side chamber and the other side chamber, and a piston rod that is connected to the piston and extends to an outside of the cylinder; a reservoir chamber that compensates for an entry and exit of the piston rod; a third communication passage communicating the one side chamber or the other side chamber and the reservoir chamber; and a third damping mechanism provided in the third communication passage. The third damping mechanism is a phase correction unit that advances a phase of a damping force by an inertial force of the working fluid in the third communication passage.

### Effect of the Invention

According to an embodiment of the present disclosure, it is possible to suppress a delay in damping force with respect to a radio-frequency vibration without controlling an actuator.

### BRIEF DESCRIPTION OF THE DRAWINGS

FIG. 1 is a vertical cross-sectional view illustrating a shock absorber according to a first embodiment.

FIGS. 2A and 2B are diagrams illustrating a relationship between the skyhook damper control rule of the shock absorber and its approximation rule.

FIG. 3 is a characteristic diagram (Lissajous graph between a displacement and a damping force) illustrating a relationship between a displacement (damper displacement) of the shock absorber and a damping force in the three cases of the damping force with phase delay, no phase delay, and phase advance.

FIG. 4 is a diagram illustrating how to calculate an axial force due to an inertial force (oil inertial force) of a working fluid.

FIG. 5 is a characteristic diagram illustrating a relationship between the displacement of the shock absorber and the damping force for each length of a communication passage (passage length).

FIG. 6 is a diagram (between a displacement and a damper axial force, between a time and a damper axial force and a piston speed) illustrating that the phase delay of the damping force is corrected by the oil inertial force.

FIG. 7 is a characteristic diagram illustrating a relationship between a frequency and a phase for each length of a communication passage (passage length).

FIG. 8 is a characteristic diagram illustrating a relationship among a relative speed, amplitude, and frequency of the shock absorber (operating region of the shock absorber).

FIGS. 9A to 9C are characteristic diagrams (between a displacement and an axial force) illustrating a damping force and a corrected damping force in three cases where the frequency and the amplitude are different from each other.

FIG. 10 is a characteristic diagram (between a piston speed and a damping force) illustrating a damping force characteristic at very low speed with and without a phase correction communication passage (phase correction device).

FIG. 11 is a vertical cross-sectional view illustrating a shock absorber according to a second embodiment.

FIG. 12 is an enlarged cross-sectional view of the (XII) portion in FIG. 11.

FIGS. 13A and 13B are plan views illustrating an introduction disk and a passage disk constituting a flow passage forming member.

FIG. 14 is a vertical cross-sectional view illustrating a piston rod, a piston, and a frequency response unit according to a modification.

FIG. 15 is a characteristic diagram illustrating a relationship between a displacement (stroke) and a damping force of a shock absorber provided with a frequency response unit according to a comparative example.

FIG. 16 is an enlarged characteristic diagram illustrating the innermost characteristic line in FIG. 15.

FIG. 17 is a characteristic diagram illustrating a time change in a damping force and a piston speed of the shock absorber provided with the frequency response unit according to the comparative example.

FIG. 18 is a vertical cross-sectional view illustrating a shock absorber according to a third embodiment.

FIG. 19 is an enlarged cross-sectional view illustrating a damping force adjusting device in FIG. 18.

FIG. 20 is an enlarged cross-sectional view illustrating a damping force adjusting valve, a frequency response unit, and a flow passage forming member in FIG. 19, with the right side of FIG. 19 facing upward.

FIGS. 21A and 21B are plan views illustrating an introduction disk and a passage disk constituting a flow passage forming member.

FIG. 22 is a characteristic diagram (between a piston speed and a damping force) illustrating a relationship between the piston speed and the damping force with and without the phase correction communication passage (phase correction device).

### DETAILED DESCRIPTION TO EXECUTE THE INVENTION

Hereinafter, with reference to the accompanying drawings, descriptions will be made on, as an example, a case where a shock absorber according to an embodiment is applied to a damping force adjustable hydraulic shock absorber mounted on a vehicle (e.g., a four-wheeled vehicle). The accompanying drawings (e.g., FIGS. 14 and 18 to 21B) are prepared with accuracy to conform to engineering drawings.

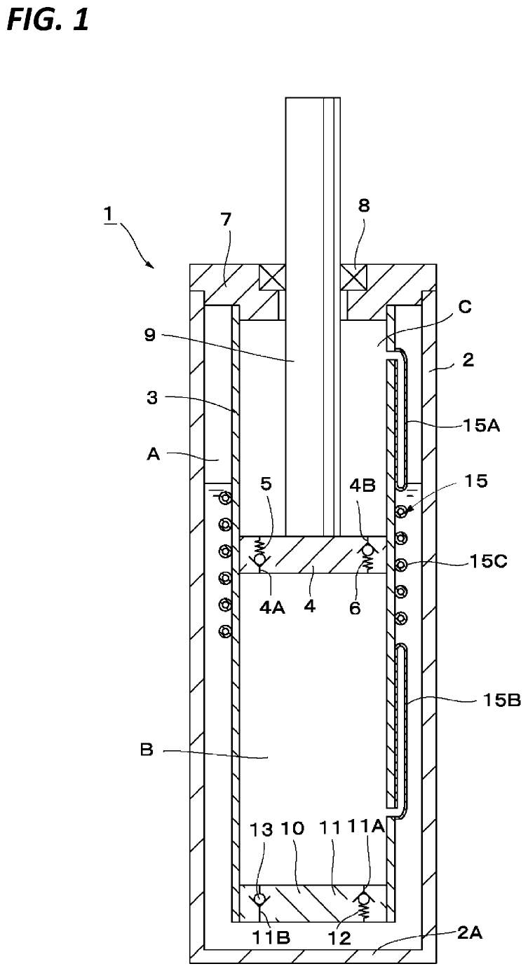

FIGS. 1 to 10 illustrate a first embodiment. In FIG. 1, a shock absorber 1 is, for example, a hydraulic shock absorber for vehicle such as an automobile. The shock absorber 1 constitutes a vehicle suspension device together with a suspension spring (not illustrated) made of, for example, a coil spring. In the following description, one axial end of the shock absorber 1 will be referred to as a “lower end” and the other axial end thereof will be referred to as an “upper end,” but one axial end of the shock absorber 1 may be referred to as the “upper end” and the other axial end thereof may be referred to as the “lower end.”

The shock absorber 1 includes an outer cylinder 2, an inner cylinder 3, a piston 4, a piston rod 9, and a phase correction communication passage 15. The outer cylinder 2 is formed in the shape of a bottomed cylinder and constitutes the outer shell of the shock absorber 1. The outer cylinder 2 is closed at its lower end, which is one end, as a bottom portion 2A, and is open at its upper end, which is the other end. An upper end opening of the outer cylinder 2 is closed by a rod guide 7 and a rod seal 8.

An inner cylinder 3 serving as a cylinder is provided coaxially within the outer cylinder 2. The inner cylinder 3, together with the outer cylinder 2, constitutes a twin-tube cylinder device (shock absorber). That is, the outer cylinder 2 is formed on the outer periphery of the inner cylinder 3. An oil liquid (hydraulic oil) serving as a working fluid (hydraulic fluid) is sealed in the inner cylinder 3 and the outer cylinder 2. The oil liquid, which is the hydraulic fluid, is not limited to oil, and may be, for example, water mixed with an additive. The inner cylinder 3 has its lower end fitted to a bottom valve 10 and is closed at its upper end by the rod guide 7. The inner cylinder 3 forms (defines) an annular reservoir chamber A between the inner cylinder 3 and the outer cylinder 2. That is, the reservoir chamber A is provided between the inner cylinder 3 and the outer cylinder 2.

Gas is sealed in the reservoir chamber A together with oil liquid, which is a working liquid. The gas may be, for example, air at atmospheric pressure, or compressed nitrogen gas. The reservoir chamber A compensates for the entry and exit of the piston rod 9. The bottom valve 10 is positioned on the lower end of the inner cylinder 3 and provided between the bottom portion 2A of the outer cylinder 2 and the inner cylinder 3. One end of the inner cylinder 3 is closed by the bottom valve 10 to form a bottomed cylinder. A mono-tube type cylinder device (shock absorber) may be constituted by a bottomed cylindrical cylinder (inner cylinder) while an outer cylinder and a bottom valve are not provided.

The piston 4 is slidably inserted into the inner cylinder 3. The piston 4 divides (defines) the inside of the inner cylinder 3 into two chambers (i.e., a bottom-side oil chamber B as one side chamber and a rod-side oil chamber C as the other side chamber). The piston 4 is provided with oil passages 4A and 4B that allow the bottom-side oil chamber B and the rod-side oil chamber C to communicate with each other. The oil passages 4A and 4B constitute passages that allow the hydraulic fluid (oil liquid) to flow from one side chamber to the other side of the oil chambers B and C in the inner cylinder 3 (cylinder) due to the movement of the piston 4. That is, the oil passages 4A and 4B, which respectively serve as first communication passages, communicate the bottom-side oil chamber B, which is one side chamber, and the rod-side oil chamber C, which is the other side chamber. The oil passage 4A and the oil passage 4B are main flow passages (first flow passages) in which the movement of the piston 4 causes the hydraulic fluid (oil liquid) to flow.

The piston 4 is provided with a contraction-side valve 5 that constitutes a contraction-side damping valve (hereinafter, referred to as a compression-side valve 5). The compression-side valve 5 is constituted by, for example, a disk valve provided above the piston 4. When the piston 4 is slidably displaced downward along the inner cylinder 3 in the contraction stroke of the piston rod 9, the compression-side valve 5 applies resistance to the oil liquid flowing through the oil passage 4A from the bottom-side oil chamber B toward the rod-side oil chamber C. As a result, a predetermined damping force is generated in the contraction stroke of the piston rod 9. That is, the compression-side valve 5 controls the flow of the working fluid (oil liquid) caused by the sliding of the piston 4 inside the inner cylinder 3 to generate a damping force. The compression-side valve 5 corresponds to a first damping mechanism provided in the oil passage 4A as the first communication passage.

The piston 4 is provided with an extension-side valve 6 that constitutes an extension-side (elongation-side) damping valve (hereinafter, referred to as an extension-side valve 6). The extension-side valve 6 is constituted by, for example, a disk valve provided below the piston 4. When the piston 4 is slidably displaced upward along the inner cylinder 3 in the extension stroke (elongation stroke) of the piston rod 9, the extension-side valve 6 applies resistance to the oil liquid flowing through the oil passage 4B from the rod-side oil chamber C toward the bottom-side oil chamber B. As a result, a predetermined damping force is generated in the extension stroke of the piston rod 9. That is, the extension-side valve 6 controls the flow of the working fluid (oil liquid) caused by the sliding of the piston 4 inside the inner cylinder 3 to generate a damping force. The extension-side valve 6 corresponds to a first damping mechanism provided in the oil passage 4B as the first communication passage.

The upper ends (open ends) of the outer cylinder 2 and the inner cylinder 3 are closed by the rod guide 7 and the rod seal 8. The rod guide 7 is a guide member that slidably guides the axial displacement of the piston rod 9. The rod guide 7 is fitted to the upper ends (open ends) of the outer cylinder 2 and the inner cylinder 3.

The rod seal 8 is provided on the upper surface of the rod guide 7. The rod seal 8 is constituted by, for example, a metallic annular plate as a core and an elastic sealing material such as rubber attached to the annular plate by means of baking. The inner periphery of the rod seal 8 is in sliding contact with the outer periphery of the piston rod 9 to liquid-tightly and air-tightly seal the piston rod 9, the outer cylinder 2, and the inner cylinder 3.

The lower end of the piston rod 9, which is the base end, is inserted into the inner cylinder 3, and the upper end of the piston rod 9, which is the tip end, protrudes out of the inner cylinder 3 through the rod guide 7. That is, the piston rod 9 is connected to the piston 4 and extends to the outside of the inner cylinder 3. The piston 4 is attached to the lower end of the piston rod 9 together with the compression-side valve 5 and the extension-side valve 6. In addition, the lower end of the piston rod 9 may be further extended to protrude outward from the bottom portion and form a so-called double rod. That is, the inner cylinder 3 has a piston rod 9 protruding from at least one end thereof.

The bottom valve 10 is provided on the lower end of the inner cylinder 3. The bottom valve 10 includes a valve body 11 that partitions (defines, separates) the reservoir chamber A and the bottom-side oil chamber B, a contraction-side throttle valve 12 provided on the valve body 11, and an extension-side check valve 13 provided on the valve body 11. The valve body 11 is provided with oil passages 11A and 11B that allow the reservoir chamber A and the bottom-side oil chamber B to communicate with each other.

It is desired to reduce the transmission of radio-frequency vibration from the unsprung portion to the sprung portion of the vehicle to further improve riding comfort. The damping force by hydraulic pressure of the damper (shock absorber) tends to cause a delay with respect to the piston speed when the operating frequency is increased. That is, in the operation of the piston, the phase delay of the damping force with respect to the piston speed tends to occur as the vibration frequency increases. This may lead to a decrease in damping performance and an increase in vibration transmission in radio-frequency vibration, resulting in a decrease in riding comfort.

The above-mentioned Patent Document 1 describes a suspension control device that compensates for a response delay due to an actuator by controlling the actuator so that the unsprung acceleration is advanced 90° in phase with respect to the piston speed. However, a shock absorber without an actuator in the related art may not externally control the flow of working fluid. Therefore, due to the phase delay of the damping force with respect to the piston speed, the force damping the sprung mass (vehicle body) may decrease, and the force exciting the sprung mass may increase. This may lead to deterioration in riding comfort with respect to the radio-frequency input.

More specifically, the hydraulic damping force generates a phase delay with respect to the piston speed. The phase delay increases as the frequency increases (i.e., as the acceleration increases). The phase delay of the damping force is small at low frequencies near sprung resonance (e.g., around 1.5 Hz) and is unlikely to cause a problem. However, as the frequency increases, the phase delay increases, and thus, there is a possibility that the effect on the radio-frequency vibration reduction performance and the sound vibration reduction performance may increase. That is, when the phase of the damping force is delayed relative to the phase of the piston speed, the damping force in the damping region tends to decrease and the damping force in the excitation region tends to increase. As a result, there is a possibility that the increase in the transmissibility of vibration to the sprung mass may lead to a decrease in riding comfort and a decrease in sound and vibration performance. There is also a possibility that unsprung vibration damping property may be affected, and unsprung rattling and wobbly feeling may worsen.

Therefore, in the embodiment, the oil inertial force is used to generate the force of the acceleration phase in which the phase is advanced than the piston speed, thereby improving the phase delay in the radio-frequency region where the phase delay is large. That is, as will be described later, in the first embodiment, a communication passage (i.e., a phase correction communication passage 15) is provided to communicate a piston upper chamber (i.e., the rod-side oil chamber C) and a piston lower chamber (i.e., the bottom-side oil chamber B) with each other and the communication passage is set to a predetermined length, whereby the pressure in the acceleration phase due to the inertial force of the oil liquid (oil) in the communication passage is applied to the working chambers (i.e., the piston upper chamber and the piston lower chamber) against the radio-frequency vibration. Thus, the phase delay of the damping force with respect to the piston speed may be resolved, and the phase may be advanced with respect to the piston speed. As a result, it is possible to increase the damping force in the damping region and decrease the damping force in the excitation region, thereby reducing sprung vibration and vibration transmission.

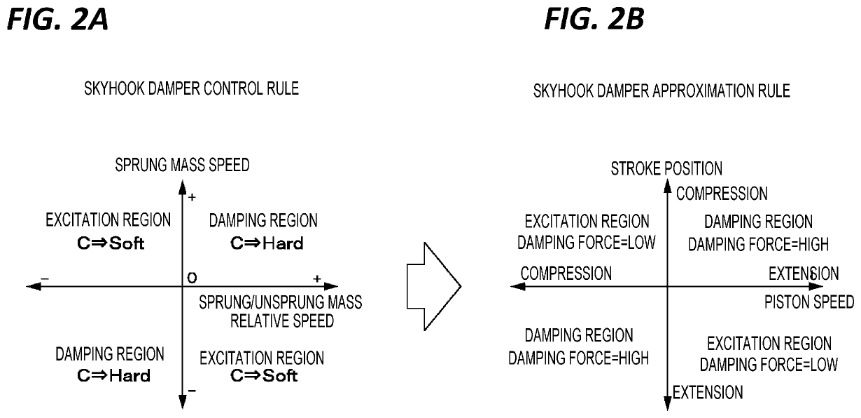

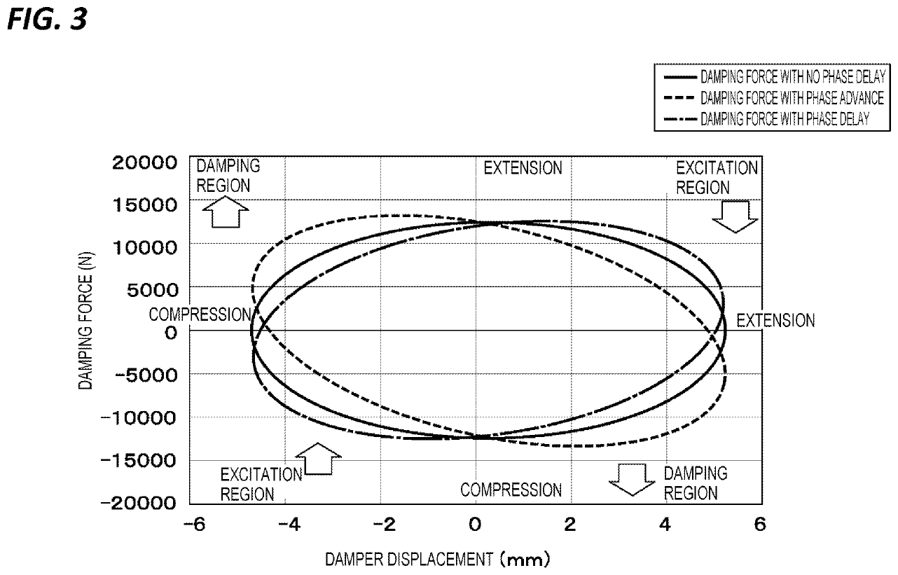

That is, FIGS. 2A and 2B and 3 illustrate a relationship between the damping force control rule of a damper and the damping force phase of the damper. As illustrated on the left sides of FIGS. 2A and 2B, a skyhook damper control is known as a control rule for the damping force of a damper, which is excellent in suppressing sprung mass vibration and reducing vibration transmission from the road surface to the sprung mass. As illustrated on the right sides of FIGS. 2A and 2B, as an approximation rule for skyhook damper control (skyhook damper approximation rule), it is known that it is effective to control the magnitude of the damping force by a damper stroke position (displacement) and an operating direction (e.g., extension, contraction). The excitation region in FIGS. 2A and 2B is a region in which the damper generates a force that excites the sprung mass. In the excitation region, the transmission to the sprung mass may be reduced by reducing the damping force. The damping region in FIGS. 2A and 2B is a region in which the damper generates a force for damping the sprung mass. In the damping region, sprung vibration may be reduced by increasing the damping force.

Meanwhile, FIG. 3 illustrates a relationship between the displacement of the shock absorber (damper displacement) and the damping force, that is, the Lissajous curves (Lissajous' waveform, hysteresis curve shape) between the displacement and the damping force. When the damping force phase of the damper with respect to the piston speed delays, the damping force in the damping region of the approximation rule tends to decrease and the damping force in the excitation region tends to increase. In this case, there is a possibility that the damping performance of the sprung mass vibration may deteriorate and the vibration transmission from the road surface to the sprung mass may increase, resulting in a decrease in riding comfort. In contrast, when the damping force phase of the damper with respect to the piston speed advances, the damping force in the damping region of the approximation rule tends to increase and the damping force in the excitation region tends to decrease. In this case, riding comfort may be improved by improving damping performance of sprung mass vibration and reducing vibration transmission from the road surface to the sprung mass.

Therefore, in the embodiment, by advancing the phase of the damping force of the damper, the damping force in the damping region is increased and the damping force in the excitation region is reduced, thereby implementing damping force characteristics according to the approximation rule. That is, in the embodiment, the oil inertial force is used to generate the force of the acceleration phase in which the phase is advanced than the piston speed, thereby improving the phase delay in the radio-frequency region where the phase delay of the hydraulic damping force is large. For this reason, in the embodiment, the damper (shock absorber) includes a phase correction mechanism (phase correction device) that corrects the phase of the damping force by the oil inertial force. As a result, it is possible to improve the phase delay of the damping force of the damper at radio frequencies and improve the riding comfort. The phase correction mechanism will be described below.

As illustrated in FIG. 1, in the first embodiment, the shock absorber 1 includes a phase correction communication passage 15 that serves as a phase correction mechanism. The phase correction communication passage 15 is provided on the outer periphery of the inner cylinder 3, in other words, in the reservoir chamber A between the inner cylinder 3 and the outer cylinder 2. The phase correction communication passage 15 is configured as a tubular conduit, and the passage length l is larger than the cross-sectional area a (e.g., 30≤passage length l/cross-sectional area a≤1200 [l/mm]). That is, the shock absorber 1 includes a cylinder-side member having an inner cylinder 3, and a piston-side member having a piston 4 and a piston rod 9 that move relative to the inner cylinder 3. The phase correction communication passage 15 for advancing the phase of the damping force by the inertial force of the working fluid is arranged in the cylinder-side member (the inner cylinder 3).

The phase correction communication passage 15 includes a linear other-side communication passage 15A (hereinafter, referred to as an upper communication passage 15A) communicating with the rod-side oil chamber C through an opening on the inner peripheral surface of the inner cylinder 3, a linear one-side communication passage 15B (hereinafter, referred to as a lower communication passage 15B) communicating with the bottom-side oil chamber B through an opening on the inner peripheral surface of the inner cylinder 3, and a spiral conduit 15C provided between the upper communication passage 15A and the lower communication passage 15B and connecting the upper communication passage 15A and the lower communication passage 15B. The spiral conduit 15C is formed as a spiral conduit that extends in the circumferential direction and advances in the axial direction. A fixed orifice (constant orifice) is not provided in the piston 4 (e.g., the compression-side valve 5 and the extension-side valve 6). The fixed orifice (constant orifice) plays a role of, for example, pipeline frictional resistance in the upper communicating passage 15A, the lower communicating passage 15B, and the spiral conduit 15C. The spiral conduit 15C is arranged near the oil level in the reservoir chamber A, which fluctuates due to the operation of the shock absorber 1.

The phase correction communication passage 15 is provided between the bottom-side oil chamber B, which is one side chamber, and the rod-side oil chamber C, which is the other side chamber. The phase correction communication passage 15 is a communication passage (second communication passage) in which the movement of the piston 4 causes the working fluid (oil liquid) to flow, similar to the first communication passage (i.e., the oil passages 4A and 4B). That is, the phase correction communication passage 15 is provided in the inner cylinder 3 (more specifically, the reservoir chamber A between the outer peripheral surface of the inner cylinder 3 and the inner peripheral surface of the outer cylinder 2), which is a cylinder-side member, and communicates the bottom-side oil chamber B and the rod-side oil chamber C with each other. A second damping mechanism is provided in the phase correction communication passage 15. In this case, the second damping mechanism is configured as a phase correction unit that advances the phase of the damping force by the inertial force of the working fluid in the phase correction communication passage 15. That is, the phase correction communication passage 15 is configured as a damping mechanism that includes a spiral conduit 15C that advances in the axial direction and turns (circulates) a plurality of times with the same diameter, thereby generating a force (axial force) that advances the phase of the damping force. In other words, the phase correction communication passage 15 is a throttle passage (orifice portion) having a large passage length (i.e., the passage length l is large relative to the cross-sectional area a) between the bottom-side oil chamber B and the rod-side oil chamber C. The spiral conduit 15C extends in the circumferential direction to a position where the starting point exceeds the end point in top view (i.e., extends over 360°). For example, the phase correction communication passage 15 may be constituted entirely of a spiral conduit by omitting the portions (the upper communication passage and the lower communication passage) that extend linearly in the axial direction.

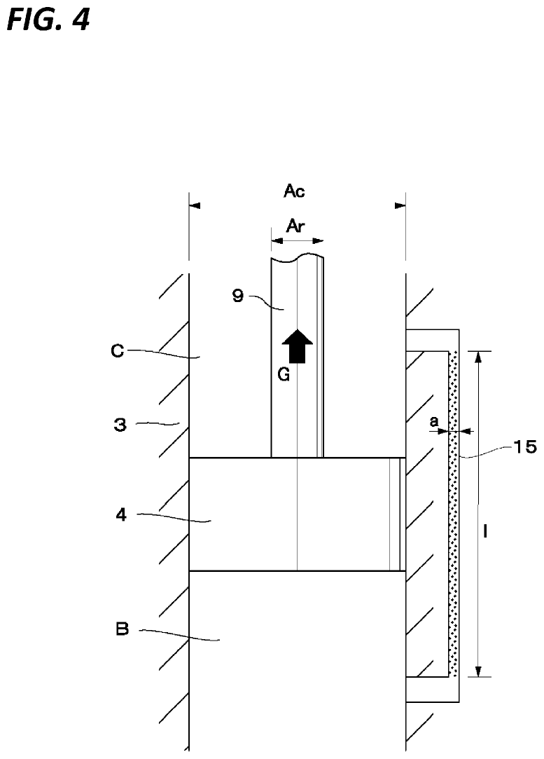

FIG. 4 is a diagram illustrating the oil inertial force. The damper axial force due to the oil inertial force is calculated with reference to FIG. 4. It is assumed that the cross-sectional area of the cylinder (inner cylinder 3) is “Ac,” the cross-sectional area of the rod (piston rod 9) is “Ar,” the cross-sectional area of the orifice portion (phase correction communication passage 15) connecting the lower chamber (bottom-side oil chamber B) and the upper chamber (rod-side oil chamber C) is “a,” the length of the orifice portion (phase correction communication passage 15) is “l,” the stroke acceleration (relative acceleration) of the damper (shock absorber 1) is “G,” and the oil density, which is the density of the oil liquid, is “ρ.” The oil mass m of the orifice portion (phase correction communication passage 15) is given by the following equation 1.

m=a=l=ρ [Equation 1]

The acceleration g acting on the oil (oil liquid) in the orifice portion (phase correction communication passage 15) when the acceleration G acts on the damper (shock absorber 1) is given by the following equation 2.

g−G×(Ac−Ar)/a [Equation 2]

At this time, the oil inertial force f of the orifice portion (phase correction communication passage 15) is given by the following equation 3.

$$f = m ⨯ g = 1 ⨯ ρ ⨯ G ⨯ ( A c - A r ) \qquad [ Equation 3 ]$$

The working pressure Δp of the pressure chambers (e.g., the bottom-side oil chamber B and the rod-side oil chamber C) due to the oil inertial force f is given by the following equation 4.

$$Δ p = f / a = 1 ⨯ ρ ⨯ G ⨯ ( A c - A r ) / a \qquad [ Equation 4 ]$$

Therefore, the axial force Fg acting in the acceleration phase of the damper (shock absorber 1) is given by the following equation 5. That is, the axial force Fg acting in the acceleration phase of the damper (shock absorber 1) due to the oil inertial force f is proportional to the “acceleration G” and the “ratio (l/a) between the length l and the cross-sectional area a of the orifice portion (phase correction communicating passage 15).”

$$F g = Δ p ⨯ ( A c - A r ) = 1 ⨯ ρ ⨯ G ⨯ {( A c - A r )}^{2} / a \qquad [ Equation 5 ]$$

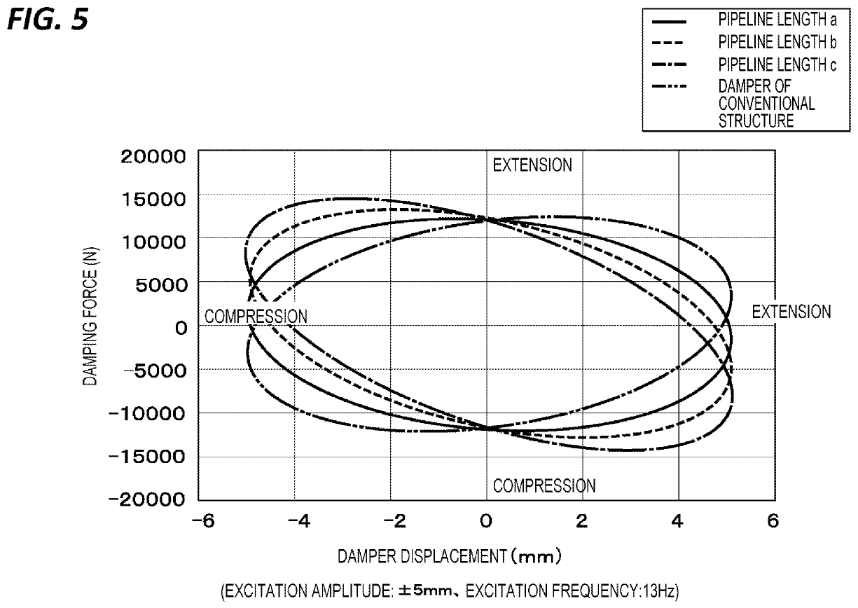

FIG. 5 illustrates the effect of oil inertial force on the damping force phase of the damper. “Pipeline lengths a, b, and c” in FIG. 5 differ from each other in length (pipeline length) of the orifice portion (phase correction communication passage 15), and a<b<c. Further, the “damper of the conventional structure” in FIG. 5 is not provided with the orifice portion (the phase correction communication passage 15). Since the oil inertial force in the phase correction communication passage 15 provided in parallel with the piston valve (i.e., the compression-side valve 5 and the extension-side valve 6) is generated in the piston acceleration phase, a pressure in a phase leading the piston speed phase may be applied to the pressure chambers (i.e., the bottom-side oil chamber B and the rod-side oil chamber C). The inertial force generates a force proportional to the acceleration, and the pressure acting on the pressure chambers (i.e., the bottom-side oil chamber B and the rod-side oil chamber C) due to the inertial force also becomes proportional to the acceleration. The magnitude of acceleration is proportional to the square of the excitation frequency of the damper (shock absorber 1).

The damping force of the damper (shock absorber 1) becomes a delayed phase as the excitation frequency increases, but may eliminate the delayed phase and advance the phase even in radio-frequency excitation by applying the influence of the inertial force. Therefore, with respect to a radio-frequency input, it is possible to increase the damping force in the damping region and decrease the damping force in the excitation region, conforming to the skyhook damper approximation rule illustrated in FIGS. 2A and 2B, and to improve the riding comfort. That is, the oil inertial force is generated in proportion to the acceleration in the phase of the damper excitation acceleration. Thus, by applying the inertial force, it is possible to improve the damping force phase in the advance direction for radio-frequency vibrations in which the phase delay of the hydraulic damping force is particularly large, and to achieve damping force characteristics that conform to the skyhook damper approximation rule. Therefore, it is possible to improve the vibration insulation performance from the road surface while damping the sprung mass (vehicle body) against radio-frequency vibrations, thereby improving the riding comfort.

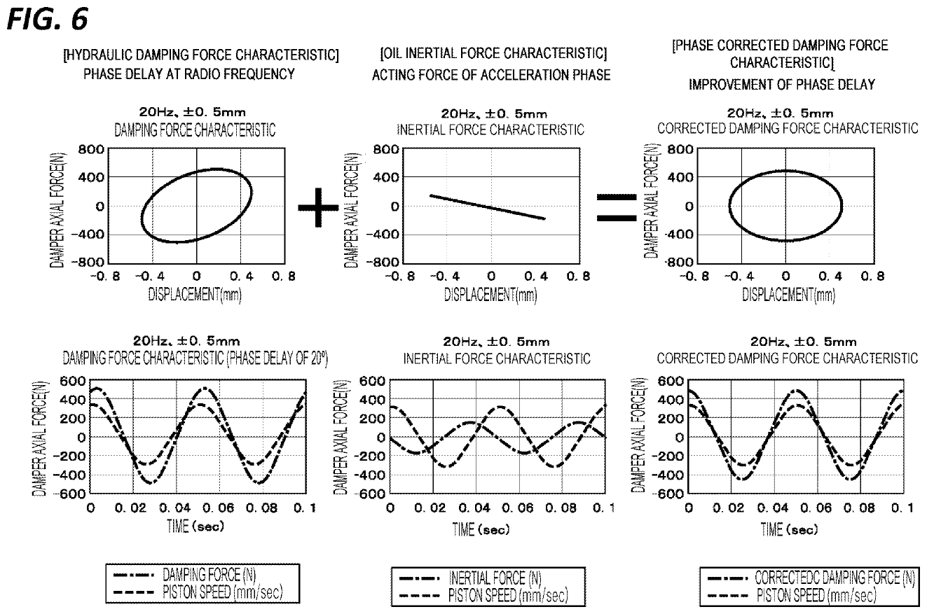

FIG. 6 illustrates the improvement effect of the phase delay due to the oil inertial force according to the embodiment. The upper parts in FIG. 6 illustrate the Lissajous waveforms of the displacement and the damper axial force, and the lower parts thereof illustrate the time-axis waveforms. In the embodiment, the oil inertial force is used to generate the force of the acceleration phase in which the phase is advanced than the piston speed. That is, the oil inertial force (axial force) is added to the delayed damping force (axial force). As a result, it is possible to improve the phase delay in a radio-frequency region where the phase delay of the hydraulic damping force becomes larger, for example, 20 Hz.

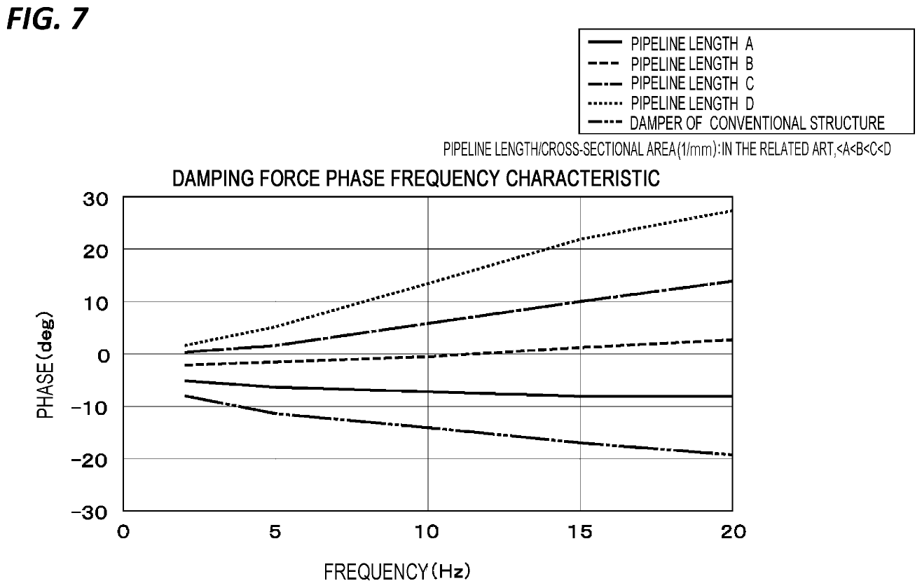

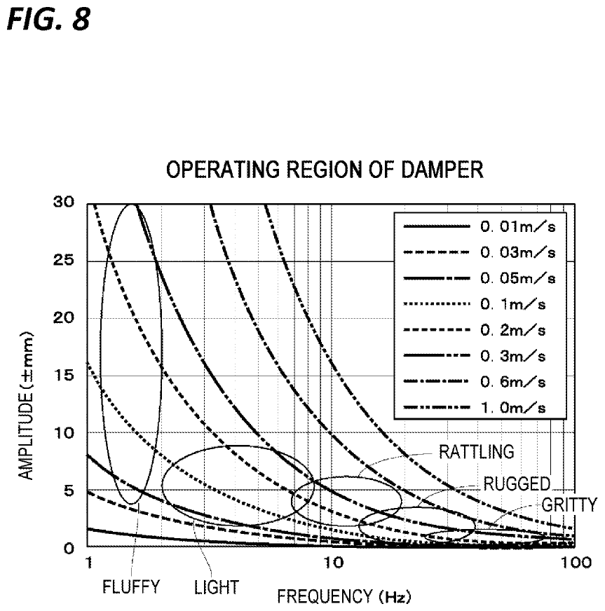

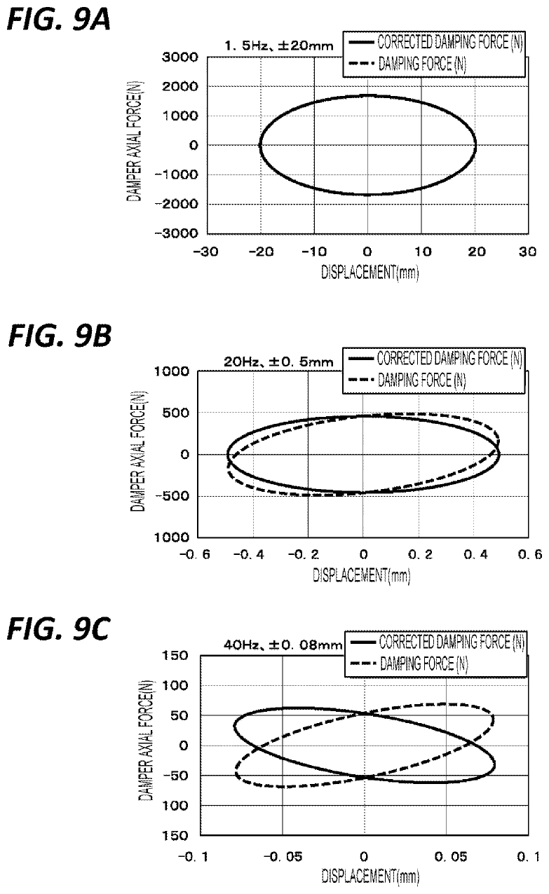

FIG. 7 illustrates a relationship between the length of the orifice portion (phase correction communication passage 15) and the phase of the damping force. The “damper of the conventional structure” in FIG. 7 is not provided with an orifice portion (phase correction communication passage 15). Further, the “pipeline lengths A, B, C, and D” in FIG. 7 are such that the ratio (l/a) of the length l of the orifice portion (the phase correction communicating passage 15) to the cross-sectional area a is A<B<C<D. FIG. 8 illustrates a relationship among the relative speed of the shock absorber, the amplitude, and the frequency (operating region of the shock absorber). FIGS. 9A to 9C illustrate the damping force and the corrected damping force (damping force corrected by the orifice portion) for three cases with different frequencies and amplitudes. FIG. 9A illustrates the damping force and the corrected damping force near the sprung resonance frequency (a low frequency and a large amplitude, e.g., a frequency of 1.5 Hz and an amplitude of ±20 mm), FIG. 9B illustrates the damping force and the corrected damping force in the rugged region (a radio frequency and a fine amplitude, e.g., a frequency of 20 Hz and an amplitude of ±0.5 mm), and FIG. 9C illustrates the damping force and the corrected damping force in the rough region (a radio frequency and fine amplitude, e.g., a frequency of 40 Hz and an amplitude of ±0.08 mm).

The magnitude of the oil inertial force is proportional to the value of the ratio (l/a) between the length l of the orifice portion (phase correction communicating passage 15) and the cross-sectional area a. Therefore, the damping force phase may be adjusted by the length l and the cross-sectional area a of the orifice portion (phase correction communication passage 15). For example, the pipeline length B in FIG. 7 is an example in which the ratio (l/a) between the length l and the cross-sectional area a is adjusted by setting the phase delay to approximately 0 near the unsprung resonance point (13 Hz). This improves the unsprung damping performance. Further, in a radio-frequency region, the damping force has an advanced phase, which makes it possible to damp sprung mass vibration and reduce vibration transmission with respect to radio-frequency vibrations. The pipeline lengths C and D in FIG. 7 are examples in which the effect on the radio-frequency vibration is further improved, and the phase of the damping force at radio frequencies is more advanced.

That is, as illustrated in FIG. 7, in the conventionally structured damper with a short pipeline length (piston body thickness of about 10 mm to 15 mm), the phase of the damping force with respect to the piston speed delays as the frequency increases. Therefore, in the vicinity of the sprung resonance (about 1.5 Hz), the delay is small and the sprung vibration may be damped. However, in the vicinity of the unsprung resonance (about 13 Hz), due to the phase delay, the unsprung mass may not be sufficiently damped, and there is a possibility that the unsprung mass may rattle. Further, with a higher frequency input, the phase delay of the damping force further increases, and the damping force on the sprung mass decreases. As a result, the transmission of vibration to the sprung mass increases, and there is a possibility that the feeling of ruggedness and grittiness may increase and the riding quality may deteriorate.

As the length l of the orifice portion (phase correction communication passage 15) increases (i.e., as l/a increases), the phase delay of the damping force with respect to the piston speed decreases. Further, by increasing the length l (l/a) of the orifice portion (phase correction communication passage 15), the phase of the damping force with respect to the piston speed at radio frequencies may be advanced. For example, when the length l (ratio l/a) is adjusted to match the phase of the damping force to the vicinity of the piston speed phase at the unsprung resonance frequency (near 13 Hz), at a higher frequency, the damping force becomes the advancing phase with respect to the piston speed. As a result, it is possible to reduce unsprung rattling, ruggedness, and grittiness at the same time, thereby improving riding comfort. Depending on the vehicle, when the reduction of transmission of radio-frequency vibration is more important than the unsprung rattling, riding comfort may be improved by further increasing the length l (ratio l/a) to further advance the phase of the radio-frequency damping force.

As illustrated in FIG. 9A, the delay in damping force is small near the sprung resonance frequency (a low frequency and a large amplitude, e.g., a frequency of 1.5 Hz and an amplitude of ±20 mm). Further, as illustrated in FIG. 9B, in the rugged region (a radio frequency and a fine amplitude, e.g., a frequency of 20 Hz and an amplitude of ±0.5 mm), the delay of the damping force is large, while the delay of the corrected damping force is small. As illustrated in FIG. 9C, in the grittiness region (a radio frequency and a fine amplitude, e.g., a frequency of 40 Hz and an amplitude of ±0.08 mm), the damping force delays further, while the corrected damping force has an advanced phase and may reduce the damping force in the excitation region. As described above, the effect of the phase correction communication passage 15, which is a phase correction device, is great in the region of radio frequency and fine amplitude, and the transmission of vibration to the sprung mass may be reduced, thereby improving the sound and vibration performance.

A shock absorber 1 according to a first embodiment has the configuration as described above, and the operation thereof will be described next.

The shock absorber 1 has, for example, a tip end (upper end) of the piston rod 9 attached to the vehicle body of the vehicle (automobile), and a base end (lower end) of the outer cylinder 2 to the wheel (axle) of the vehicle. As a result, when vibration occurs while the vehicle is running, the piston rod 9 is extended and contracted, and a damping force is generated by the compression-side valve 5, the extension-side valve 6, and the phase correction communication passage 15 of the piston 4, whereby the vibration at this time is damped.

That is, when the piston rod 9 is in the contraction stroke, the pressure inside the bottom-side oil chamber B is higher than that in the rod-side oil chamber C. The oil liquid (pressure oil) in the bottom-side oil chamber B flows into the rod-side oil chamber C through the phase correction communication passage 15 provided in parallel with the oil passage 4A of the piston 4, and the damping force (oil inertial force) is generated. Further, the oil liquid in the bottom-side oil chamber B flows through the oil passage 4A of the piston 4 and the compression-side valve 5 into the rod-side oil chamber C to generate a damping force. At this time, an amount of oil liquid corresponding to the volume of the piston rod 9 entering the inner cylinder 3 flows from the bottom-side oil chamber B into the reservoir chamber A through the throttle valve 12 of the bottom valve 10. As a result, the gas sealed inside is compressed in the reservoir chamber A, and the volume of the piston rod 9 entering the inner cylinder 3 is absorbed.

Meanwhile, when the piston rod 9 is in the extension stroke, the inside of the rod-side oil chamber C is in a higher pressure state than the bottom-side oil chamber B. The oil liquid (pressure oil) in the rod-side oil chamber C flows into the bottom-side oil chamber B through the phase correction communication passage 15 provided in parallel with the oil passage 4B of the piston 4, and the damping force (oil inertial force) is generated. Further, the oil liquid in the rod-side oil chamber C flows through the oil passage 4B of the piston 4 and the extension-side valve 6 into the bottom-side oil chamber B to generate a damping force. At this time, an amount of oil liquid corresponding to the advance volume (retraction volume) of the piston rod 9 advanced (retracted) from the inner cylinder 3 flows from the inside of the reservoir chamber A into the bottom-side oil chamber B via the check valve 13 of the bottom valve 10.

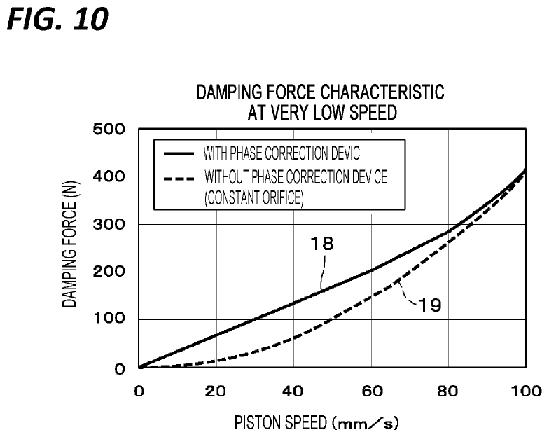

FIG. 10 illustrates damping force characteristics of a damper (shock absorber) at very low speeds. In FIG. 5, a solid line 18 indicates the damping force characteristic of the shock absorber 1 of the embodiment provided with the phase correction device (phase correction communication passage 15). A dashed line 19 indicates the damping force characteristic of a shock absorber of a comparative example (having a normal constant orifice) without a phase correction device (phase correction communication passage 15). In the embodiment, the Reynolds number at very low speed may be reduced and the friction loss of the flow passage may be increased by increasing the length of the flow passage as compared with the comparative example (normal constant orifice). That is, the phase correction device (phase correction communication passage 15) generates a damping force substantially proportional to the flow rate in a nearly laminar flow around the time of starting when the Reynolds number is small. As the flow rate increases and the Reynolds number increases, the characteristic becomes proportional to the square of the flow rate. Meanwhile, the constant orifice has a characteristic that is approximately proportional to the square of the flow rate from the start. Thus, in the embodiment, it is possible to increase the rise of the damping force at very low speeds compared to the comparative example (normal constant orifice). As a result, it is possible to increase the rise response of the damping force and improve the steering stability. That is, the phase correction device (phase correction communication passage 15) is excellent in damping force rise characteristics at very low speeds.

As described above, in the first embodiment, the phase of the damping force may be advanced by the phase correction communication passage 15, which is the phase correction unit. In this case, the phase correction communication passage 15 may be configured by, for example, increasing the passage length l with respect to the cross-sectional area a (e.g., 30≤l/a≤1200 [l/mm]). Thus, for example, with respect to radio-frequency vibration, the pressure of the acceleration phase due to the inertial force (oil inertial force) of the working fluid in the phase correction communication passage 15 may be applied to the bottom-side oil chamber B or the rod-side oil chamber C, which is the working chamber of the cylinder (i.e., the upper and lower chambers of the piston). As a result, the damping force phase may be advanced with respect to the piston speed phase, the damping force in the damping region for the sprung mass (body) of the vehicle may be increased, and the damping force in the excitation region may be reduced. Therefore, it is possible to reduce the sprung vibration damping property and the transmission of vibration, and improve the riding comfort with respect to the radio-frequency input. In this case, the damping force phase may be matched with the piston speed phase near the unsprung resonance frequency by appropriately adjusting the length l of the phase correction communication passage 15. As a result, the unsprung vibration may be appropriately damped by the damping force of the shock absorber 1, and the rattling of the unsprung mass may be suppressed to improve the riding comfort (improve the wobbly feeling).

Further, in the first embodiment, the phase correction communication passage 15 is provided in the reservoir chamber A. In this case, the phase correction communication passage 15 that generates the inertial force (oil inertial force) of the working fluid includes a spiral conduit 15C that circulates around the outer circumference of the inner cylinder 3 serving as a cylinder. The spiral conduit 15C is arranged at the liquid level position (oil level position) of the reservoir chamber A. Therefore, it is possible to suppress jumping of the oil surface when the shock absorber 1 operates at high speed. That is, the spiral conduit 15C serves as a baffle structure that suppresses jumping of the oil level with respect to fluctuations in the oil level when the shock absorber 1 strokes, thereby suppressing the occurrence of aeration. As a result, lag (missing) in the damping force waveform due to suppression of aeration may be reduced, and damping performance and noise suppression may be achieved.

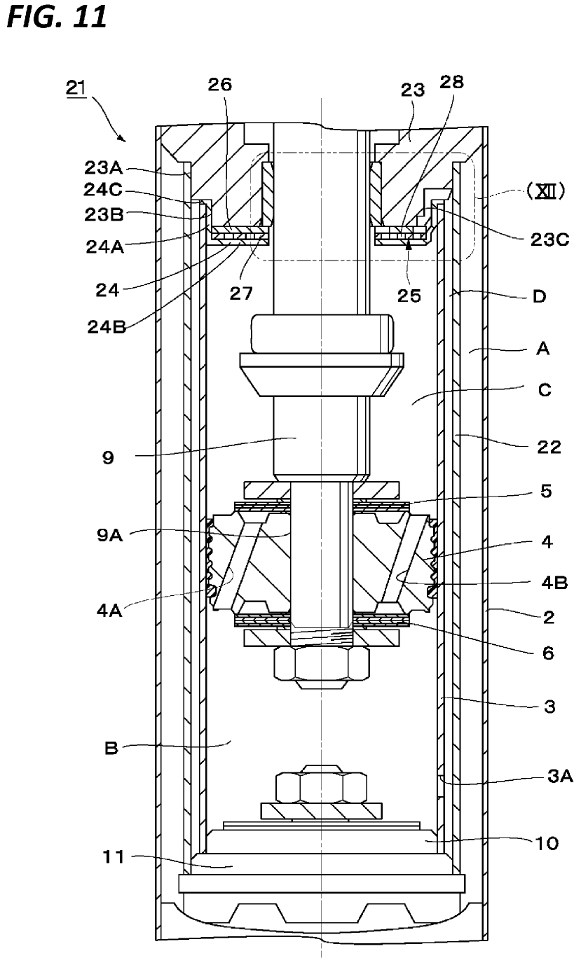

Next, FIGS. 11 to 13B illustrate a second embodiment. A feature of the second embodiment lies in that a phase correction device (phase correction unit) is provided in the rod guide. In the second embodiment, the same reference numerals are given to the same constituent elements as in the first embodiment described above, and the descriptions thereof will be omitted.

A shock absorber 21 of the second embodiment includes an outer cylinder 2, an inner cylinder 3, an intermediate cylinder 22, a piston 4, a piston rod 9, a rod guide 23, and a flow passage forming member 25 forming a phase correction communication passage 28. At one end (lower end) of the inner cylinder 3 in the longitudinal direction (axial direction), an oil hole 3A is drilled in the radial direction so that the bottom-side oil chamber B always communicates with the annular oil chamber D. The intermediate cylinder 22 is arranged between the outer cylinder 2 and the inner cylinder 3. One end (lower end) of the intermediate cylinder 22 in the axial direction is fitted to the valve body 11 of the bottom valve 10, and the other end (upper end) thereof in the axial direction is fitted to an outer cylindrical portion 23A of the rod guide 23.

The intermediate cylinder 22 surrounds the outer circumference of the inner cylinder 3 and extends in the axial direction. The intermediate cylinder 22 forms an axially extending annular oil chamber D between itself and the inner cylinder 3. The annular oil chamber D is an oil chamber independent of the reservoir chamber A. The annular oil chamber D is always communicated with the bottom-side oil chamber B through the oil hole 3A formed radially in the inner cylinder 3. The annular oil chamber D constitutes a second communication passage together with the phase correction communication passage 28. The second communication passage is provided in parallel with the piston valve (i.e., the compression-side valve 5 and the extension-side valve 6). That is, the second communication passage is provided in the inner cylinder 3 (more specifically, the inner cylinder 3 and the rod guide 23), which is a cylinder-side member, and communicates the bottom-side oil chamber B and the rod-side oil chamber C.

The rod guide 23 positions the upper portion of the inner cylinder 3 at the center of the outer cylinder 2 and guides the piston rod 9 axially slidably on the inner periphery thereof. The rod guide 23 is provided at an opening of the inner cylinder 3 that serves as a cylinder, and guides the piston rod 9. The rod guide 23 constitutes a cylinder-side member together with the inner cylinder 3. That is, the cylinder-side member includes the inner cylinder 3 and the rod guide 23. The rod guide 23 includes an outer cylindrical portion 23A to which the intermediate cylinder 22 is attached, and an inner cylindrical portion 23B to which the inner cylinder 3 and the flow passage forming member 25 are attached via a cover 24. A communication groove 23C is formed in the rod guide 23 from the inner cylindrical portion 23B to the outer cylindrical portion 23A. The communication groove 23C is a connection passage that connects the phase correction communication passage 28 formed by the flow passage forming member 25 and the annular oil chamber D.

The flow passage forming member 25 forms a phase correction communication passage 28. The flow passage forming member 25 is attached to the rod guide 23 via the cover 24. Thus, the phase correction communication passage 28 is provided in the rod guide 23. The flow passage forming member 25 forms a swirling-shaped phase correction communication passage 28 by stacking two disks 26 and 27. That is, the flow passage forming member 25 includes an introduction disk 26 and a passage disk 27 which are stacked to form a phase correction communication passage 28. The flow passage forming member 25, that is, the introduction disk 26 and the passage disk 27 are attached to the rod guide 23 while being housed in the cover 24 serving as a housing member.

The cover 24 is formed, for example, by press molding and includes a cylindrical portion 24A, a bottom portion 24B that closes one end (lower end) of the cylindrical portion 24A, and a flange portion 24C that is provided on the other end (upper end) of the cylindrical portion 24A and protrudes radially along the entire circumference. The bottom portion 24B is provided with a center hole 24B1 through which the piston rod 9 is inserted. The cylindrical portion 24A is fitted to the inner cylindrical portion 23B of the rod guide 23 in a state where the introduction disk 26 and the passage disk 27 are sandwiched between the bottom portion 24B and the rod guide 23. A positioning protrusion 24A1 that engages with the positioning concave portions 26D and 27D of the introduction disk 26 and the passage disk 27 is provided inside the cylindrical portion 24A. The flange portion 24C is sandwiched between the opening edge on the other end (upper end) of the inner cylinder 3 and the rod guide 23.

The introduction disk 26 includes a center hole 26A provided in the center through which the piston rod 9 is inserted, a slit-shaped through groove 26B extending radially from the center hole 26A, and a closing portion 26C closing a through groove 27A of the passage disk 27. Meanwhile, the passage disk 27 includes a slit-shaped through groove 27A that extends in a swirling shape in the circumferential direction from a position corresponding to the end of the through groove 26B of the introduction disk 26 (i.e., the end opposite to the center hole 26A). Further, the passage disk 27 includes a center hole 27E through which the piston rod 9 is inserted in the center. The through groove 27A of the passage disk 27 is formed in a swirling shape in which the diameter gradually expands or contracts while extending in the circumferential direction. That is, the through groove 27A is formed in a swirling shape extending around the same plane.

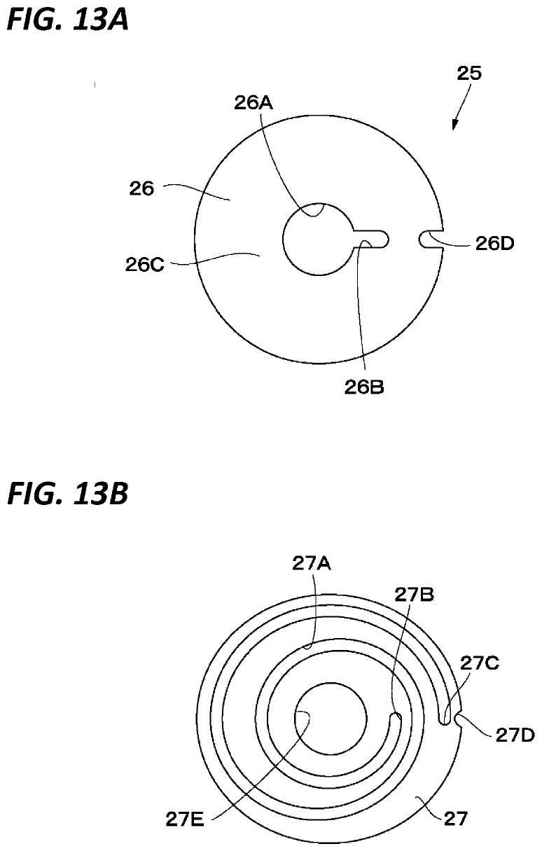

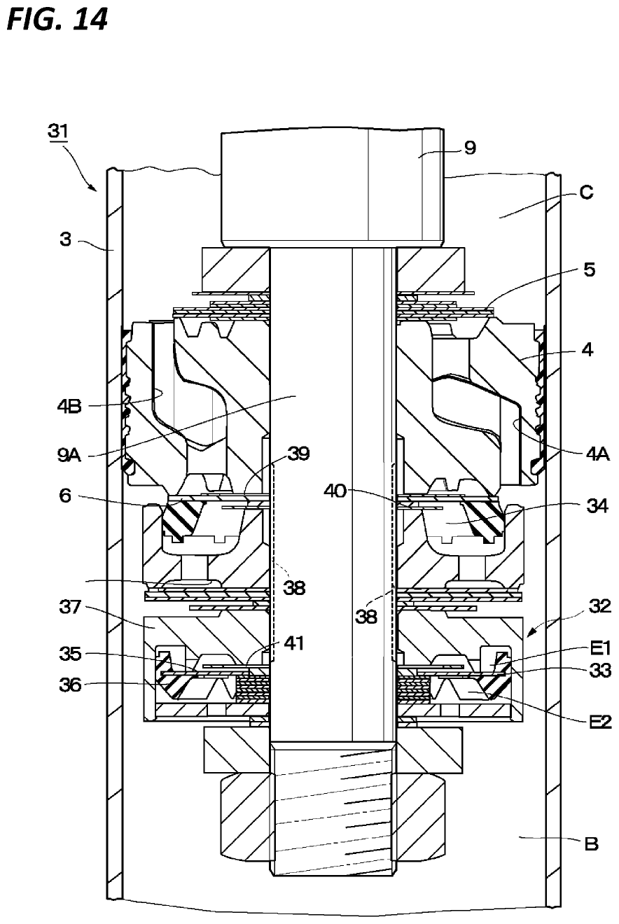

In this case, as illustrated in FIGS. 13A and 13B, the through groove 27A extends from an end portion 27B on the radially innermost inner diameter side of the passage disk 27 to an end portion 27C on the radially outermost outer diameter side in the circumferential direction (clockwise) by 720°. Thus, the through groove 27A of the passage disk 27 extends in the circumferential direction to a position where the starting point exceeds the end point (i.e., extends over 360°). The through groove 27A of the passage disk 27 is axially closed by the closing portion 26C of the introduction disk 26 and the bottom portion 24B of the cover 24. As a result, the through groove 27A of the passage disk 27 forms a phase correction communication passage 28 that serves as a throttle passage (orifice portion).

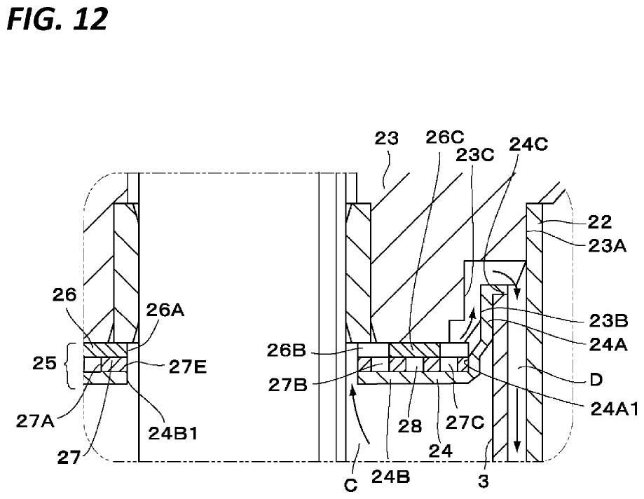

As indicated by arrows in FIG. 12, the center hole 26A and the through groove 26B of the introduction disk 26 serve as introduction passages that guide the oil liquid (hydraulic oil) in the rod-side oil chamber C to the inner diameter side end 27B on the upstream side (one side) of the through groove 27A of the passage disk 27. The closing portion 26C of the introduction disk 26 closes the through groove 27A of the passage disk 27 so that the oil liquid supplied to the inner diameter side end 27B of the through groove 27A of the passage disk 27 flows in the circumferential direction to the outer diameter side end 27C, which is the downstream side of the through groove 27A (the other side at a position different from the one side). The bottom portion 24B of the cover 24 closes the through groove 27A of the passage disk 27 so that the oil liquid supplied to the inner diameter side end 27B of the through groove 27A of the passage disk 27 flows in the circumferential direction to the outer diameter side end 27C of the through groove 27A. That is, the closing portion 26C of the introduction disk 26 and the bottom portion 24B of the cover 24 close the through groove 27A of the passage disk 27 from both sides in the penetrating direction (vertical direction). As a result, the oil liquid in the through groove 27A may flow clockwise or counterclockwise in the through groove 27A as the piston 4 moves.

The outer peripheral surface of the introduction disk 26 and the outer peripheral surface of the passage disk 27 are provided with positioning concave portions 26D and 27D that are recessed radially inward from other portions. The positioning concave portion 26D of the introduction disk 26 is provided, for example, at a position corresponding to the through groove 26B extending in the radial direction (i.e., a position where phases in the circumferential direction match). The positioning concave portion 26D of the introduction disk 26 extends further to the inner diameter side than the positioning concave portion 24D of the passage disk 27. In this case, the positioning concave portion 26D of the introduction disk 26 extends to a position corresponding to the outer diameter side end 27C of the through groove 27A of the passage disk 27. As a result, the positioning concave portion 26D of the introduction disk 26 allows the outer diameter side end 27C of the through groove 27A of the passage disk 27 and the communication groove 23C of the rod guide 23 to communicate with each other. The positioning concave portion 27D of the passage disk 27 is provided at a position corresponding to, for example, the end (i.e., the inner diameter side end 27B, the outer diameter side end 27C) of the through groove 27A (i.e., a position where the phases in the circumferential direction match). The positioning concave portions 26D and 27D are engaged with a positioning convex portion 24A1 provided on the inner peripheral surface of the cylindrical portion 24A of the cover 24. As a result, the introduction disk 26 and the passage disk 27 are positioned in the circumferential direction and suppressed from being displaced (rotated) in the circumferential direction.

In the extension stroke of the piston rod 9, the oil liquid from the rod-side oil chamber C passes through the center hole 24B1 of the cover 24, the center hole 27E of the passage disk 27, the center hole 26A of the introduction disk 26, the through groove 26B of the introduction disk 26, the inner diameter side end 27B of the through groove 27A of the passage disk 27, and the swirling-shaped through groove 27A, and flows into the bottom-side oil chamber B through the outer diameter side end 27C of the through groove 27A, the positioning concave portion 26D of the introduction disk 26, the communication groove 23C of the rod guide 23, the annular oil chamber D, and the oil hole 3A of the inner cylinder 3. In the contraction stroke of the piston rod 9, the oil liquid from the bottom-side oil chamber B passes through the oil hole 3A of the inner cylinder 3, the annular oil chamber D, the communication groove 23C of the rod guide 23, the positioning concave portion 26D of the introduction disk 26, the outer diameter side end 27C of the through groove 27A of the passage disk 27, and the swirling-shaped through groove 27A, and flows into the rod-side oil chamber C through the inner diameter side end 27B of the through groove 27A, the through groove 26B of the introduction disk 26, the center hole 26A of the introduction disk 26, the center hole 27E of the passage disk 27, and the center hole 24B1 of the cover 24.

Thus, in the second embodiment, the phase correction communication passage 28 is formed by the flow passage forming member 25 (more specifically, the swirling-shaped through groove 27A of the passage disk 27). The phase correction communication passage 28 is provided between the bottom-side oil chamber B, which is one side chamber, and the rod-side oil chamber C, which is the other side chamber. The phase correction communication passage 28 is a communication passage (second communication passage) in which the movement of the piston 4 causes the working fluid (oil liquid) to flow, similar to the first communication passage (i.e., the oil passages 4A and 4B). A second damping mechanism is provided in the phase correction communication passage 28. In this case, the second damping mechanism is configured as a phase correction unit that advances the phase of the damping force by the inertial force of the working fluid in the phase correction communication passage 28. That is, the phase correction communication passage 28 is configured as a damping mechanism that generates a force (axial force) that advances the phase of a damping force in addition to generating the damping force as an orifice by including a swirling-shaped through groove 27A that continuously turns (turns multiple times) while changing the distance from the center on the same plane.

In the second embodiment, the rod guide 23 is provided with the phase correction communication passage 28 as described above, and its basic action is not particularly different from that of the first embodiment described above. Particularly, in the second embodiment, the phase correction communication passage 28 is provided in the rod guide 23. In this case, the phase correction communication passage 28 that generates the inertial force (oil inertial force) of the working fluid is constructed by stacking the disks 26 and 27. Therefore, the length of the phase correction communication passage 28 may be adjusted according to the number of disks 26 and 27. As a result, it is possible to easily adjust the inertial force of the working fluid in the phase correction communication passage 28 as desired, that is, to match the inertial force with the desired damping force characteristic.

In the first and second embodiments, as examples, descriptions have been made on the dampers of the related art, that is, shock absorbers 1 and 21 that do not include a frequency response unit that adjusts the damping force according to the excitation frequency. However, the present disclosure is not limited thereto. For example, as in a modification illustrated in FIG. 14, the damper 31 may be configured to include a frequency response unit 32 that adjusts the damping force according to the excitation frequency. Here, the frequency response unit has a great effect of reducing the damping force (peak value) of radio-frequency amplitude, but as the frequency becomes higher, the phase delay tends to become larger. That is, since the frequency response unit includes movable portions such as a free valve and a free piston, the phase delay tends to be larger than that of a damper of the related art that does not include a frequency response unit.

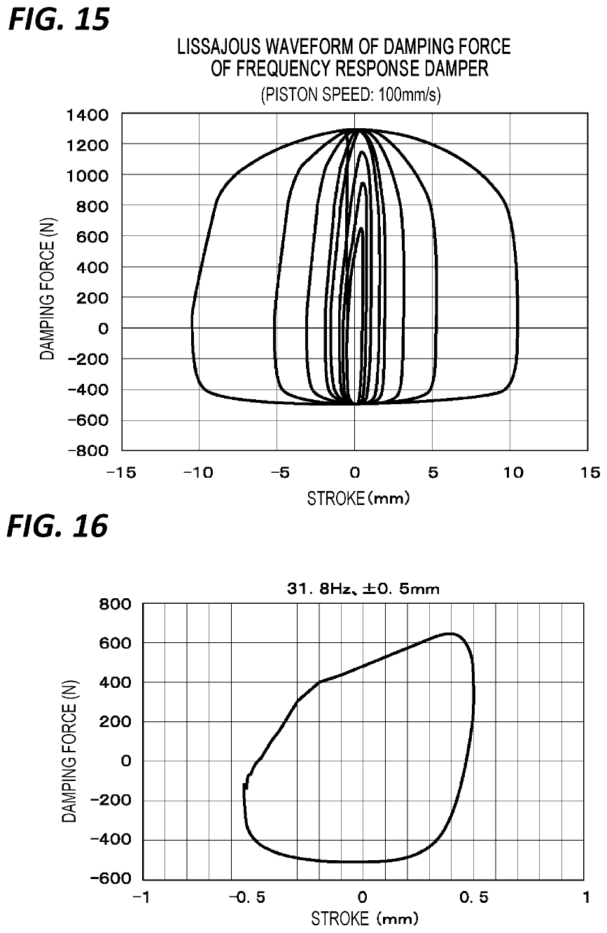

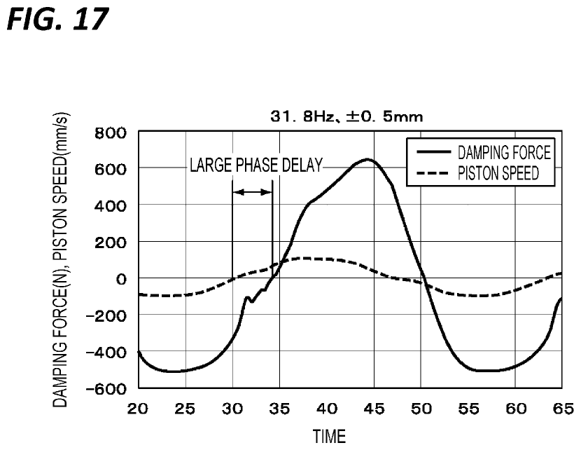

FIG. 15 illustrates a relationship (Lissajous waveform) between the stroke (displacement) and the damping force of the frequency responsive shock absorber according to the comparative example. The frequency responsive shock absorber according to the comparative example does not include the phase correction passages 15 and 28 as in the first or second embodiment. FIG. 16 illustrates an enlarged view of the innermost characteristic line in FIG. 15. That is, the characteristic line in FIG. 16 indicates the characteristic (Lissajous waveform) of radio-frequency fine amplitude (e.g., a frequency of 31.8 Hz and an amplitude of ±0.05 mm). FIG. 17 illustrates time changes in the damping force and the piston speed at the time of radio-frequency fine amplitude (e.g., a frequency of 31.8 Hz and an amplitude of ±0.05 mm). As illustrated in FIGS. 16 and 17, the frequency responsive shock absorber according to the comparative example, which does not include the phase correction passages 15 and 28, tends to have a large phase delay at radio frequencies. That is, since the phase delay of the frequency responsive shock absorber becomes larger as the frequency becomes higher, it is preferable to improve the phase delay in order to make the frequency response effect more effective.

Therefore, in the modification, a frequency response unit 32 is provided in the piston rod 9 of the shock absorbers 1 and 21 including the phase correction communication passages 15 and 28 as in the first or second embodiment. That is, as illustrated in FIG. 14, the shock absorber 31 of the modification includes, for example, an outer cylinder (not illustrated), an inner cylinder 3, a piston 4, a piston rod 9, the phase correction communication passage 15 (see, e.g., FIG. 1) of the first embodiment or the phase correction communication passage 28 (see, e.g., FIG. 11) of the second embodiment, and a frequency response unit 32.

The frequency response unit 32 is, for example, similar to the damping force generating mechanism described in International Publication No. WO 2017/047661. The frequency response unit 32 is provided on the piston rod 9. The frequency response unit 32 includes a free valve 33 serving as a moving member that may be moved by the working oil (working fluid) of the bottom-side oil chamber B and the rod-side oil chamber C. That is, the frequency response unit 32 includes a back pressure chamber 34 that acts on the extension-side valve 6 of the piston 4, a free valve 33 that acts on the pressure inside the back pressure chamber 34, and a case 37. The free valve 33 includes a disk valve 35 and an elastic seal member 36 as a spring member that biases the disk valve 35. The interior of the case 37 is divided by the free valve 33 into a frequency response damper upper chamber E1 and a damper lower chamber E2.

A recessed groove 38 is formed on the outer peripheral surface of a small diameter portion 9A of the piston rod 9 to extend in the axial direction. The recessed groove 38 communicates with the oil passage 4B of the piston 4 via a passage 39. Further, the recessed groove 38 communicates with the back pressure chamber 34 of the extension-side valve 6 via the orifice 40. The recessed groove 38 communicates with the damper upper chamber E1 of the free valve 33 through an oil guide passage 41. Thus, the damper upper chamber E1 communicates with the back pressure chamber 34 via the oil guide passage 41, the recessed groove 38, and the orifice 40. Also, the back pressure chamber 34 communicates with the oil passage 4B of the piston 4 (i.e., the rod-side oil chamber C) via the orifice 40, the recessed groove 38, and the passage 39. The volume in the damper upper chamber E1 is expanded or reduced by displacement (including elastic deformation) of the free valve 33 (i.e., the disk valve 35 and the elastic seal member 36).

For example, in the extension stroke of the piston rod 9, the displacement (including elastic deformation) of the disk valve 35 of the free valve 33 and the elastic seal member 36 expands the volume in the damper upper chamber E1. In the expanded range, the pressure oil in the back pressure chamber 34 flows toward the damper upper chamber E1. Thus, the pressure in the back pressure chamber 34 falls by the displacement of the free valve 33, and the valve opening set pressure of the extension-side valve 6 is lowered accordingly. As a result, the extension-side valve 6 is switched from a hard state to a soft state in terms of the generated damping force characteristics around a cutoff frequency fc.

That is, the free valve 33 operates as a frequency response valve that adjusts the internal pressure of the damper upper chamber E1 (i.e., the back pressure chamber 34) according to the vibration frequency of the piston rod 9 and/or the inner cylinder 3. As a result, when the vibration frequency of the piston rod 9 and/or the inner cylinder 3 is a low frequency lower than the cutoff frequency fc, the pressure in the back pressure chamber 34 of the extension-side valve 6 is not lowered by the free valve 33, and the valve opening set pressure is maintained at a relatively high pressure. When the vibration frequency is at a radio frequency equal to or higher than the cutoff frequency fc, since the pressure in the back pressure chamber 34 is lowered by the free valve 33 and the valve opening set pressure of the extension-side valve 6 is lowered, the characteristic of the generated damping force is switched to a soft state. Meanwhile, since the configuration of the frequency response unit 32 is described in International Publication No. WO 2017/047661, further detailed description will be omitted.

A modification relates to a technique in which the frequency response unit 32 as described above is provided in the piston rod 9 of the shock absorbers 1 and 21 provided with the phase correction communication passages 15 and 28 of the first or second embodiment. There is no particular difference in its basic action from those of the above-described first and second embodiments. In particular, since the second embodiment includes the frequency response unit 32, the frequency response unit 32 may reduce the damping force during radio-frequency vibration.

Although the frequency responsive shock absorber has a great effect of reducing the damping force (peak value) of the radio-frequency fine amplitude, the phase delay tends to increase as the radio-frequency fine amplitude becomes higher. In other words, when the frequency response unit 32, which is a movable portion, is provided, the phase delay tends to increase. In the modification, since the phase delay may be suppressed by the phase correction communication passages 15 and 28, which are the phase correction units, the effect of frequency response may be improved. That is, it is possible to improve the phase delay of the radio frequency, further reduce the vibration transmission of the radio frequency input, and further improve the riding comfort.

In the modification, the frequency response unit 32 is provided on the piston rod 9. In this case, the frequency response unit 32 includes a back pressure chamber 34 acting on the extension-side valve 6 of the piston 4, a free valve 33 (disk valve 35) acting on the pressure in the back pressure chamber 34, and a spring member (elastic sealing member 36) that biases the free valve 33 (disk valve 35). Thus, the frequency response unit 32 may adjust the pressure of the back pressure chamber 34 which acts on the extension-side valve 6 according to a frequency. It is possible to suppress the phase delay of the frequency response unit 32, which is a movable portion provided on the piston rod 9, by the phase correction communicating passages 15 and 28.

In the modification, as an example, descriptions have been made on the case where the frequency response unit 32 includes the free valve 33 as a moving member. However, the present disclosure is not limited thereto. For example, the frequency response unit may include a free piston as a moving member that may be moved by the working fluid of the bottom-side oil chamber (one side chamber) and/or the rod-side oil chamber (other side chamber). In this case, the frequency response unit may be provided, for example, on the lower end side of the piston rod. The frequency response unit includes a case that is displaced in the inner cylinder integrally with the piston rod, a free piston that is provided in the case and is movable (relatively displaceable) in the case, and a spring member that biases the free piston (e.g., an O-ring).

In the modification, as an example, descriptions have been made on the case where the frequency response unit 32 acts on the back pressure chamber 34 of the extension-side valve 6 which is the second valve of the piston 4. However, the present disclosure is not limited thereto, and the frequency response unit may be configured to act on the back pressure chamber of the compression-side valve 5, which is, for example, the first valve of the piston. Further, for example, the frequency response unit may be configured to act on both the back pressure chamber of the first valve and the back pressure chamber of the second valve. That is, the frequency response unit may be configured to act on the back pressure chamber of the first valve and/or the back pressure chamber of the second valve. In other words, the moving member (i.e., the free valve and the free piston) of the frequency response unit may be made movable by the working fluid in one side chamber and/or the other side chamber.

In the first and second embodiments, as examples, descriptions have been made on the dampers of the related art, that is, shock absorbers 1 and 21 that do not include a damping force adjusting mechanism that adjusts the damping force by an actuator. However, the present disclosure is not limited thereto, and the shock absorber may be configured to include, for example, a damping force adjusting mechanism that adjusts the damping force using an actuator. That is, the shock absorber includes the phase correction communication passages 15 and 28 as in the first embodiment or the second embodiment, and a damping force adjusting mechanism (e.g., a damping force adjusting valve) that adjusts the damping force by an electric actuator such as a stepping motor or solenoid. In this case, the damping force may be variably adjusted by the damping force adjusting mechanism. Even when the damping force adjusting mechanism does not perform a control for compensating for the response delay, the phase correction communication passages 15 and 28 may suppress the phase delay caused by the damping force adjusting mechanism, which is a movable portion. Therefore, it is possible to further improve riding comfort.

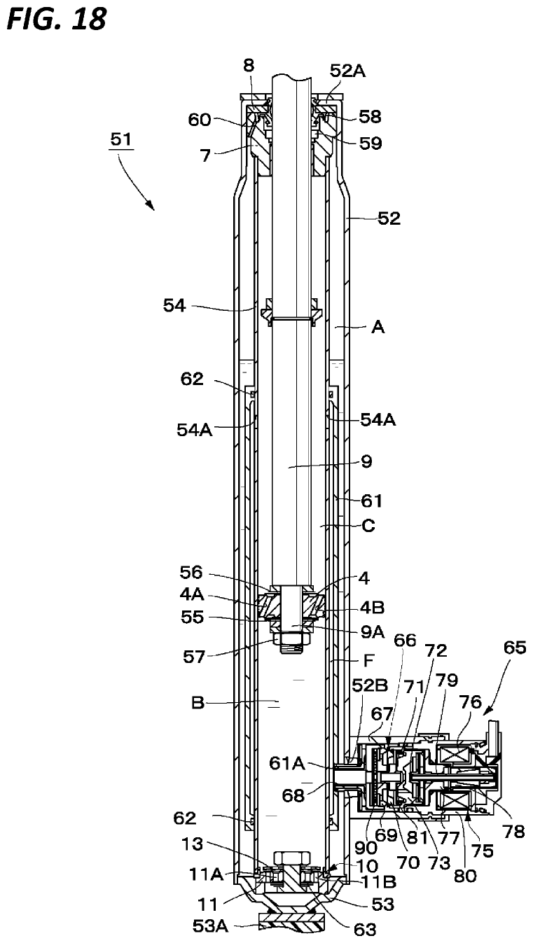

Next, FIGS. 18 to 22 illustrate a third embodiment. The feature of the third embodiment is that the shock absorber is provided with a damping force adjusting valve, and the damping force adjusting valve is provided with a frequency response unit and a phase correction unit (phase correction device). In the third embodiment, the same constituent elements as those in the first embodiment, the second embodiment, and the modification described above are denoted by the same reference numerals, and descriptions thereof are omitted.

In FIG. 18, the shock absorber 51 is configured as a uniflow damping force adjustable hydraulic shock absorber capable of adjusting the damping force according to a control command from a controller (not illustrated). That is, the shock absorber 51 includes an outer cylinder 52, an inner cylinder 54, a piston 4, a piston rod 9, a rod guide 7, an intermediate cylinder 61, a bottom valve 10, and a damping force adjusting device 65. The damping force of the shock absorber 51 is variably adjusted by the damping force adjusting device 65 according to the control command from the controller.

The outer cylinder 52 is formed in the shape of a bottomed cylinder, and constitutes the outer shell of the shock absorber 51. One end of the outer cylinder 52 is closed by welding a bottom cap 53, and the other end of the outer cylinder 52 is a caulked portion 52A bent radially inward. A rod guide 7 and a rod seal 8 are provided between the caulked portion 52A and the inner cylinder 54. Meanwhile, an opening 52B is formed concentrically with the connection port 61A of the intermediate cylinder 61 on the lower part of the outer cylinder 52. A damping force adjusting device 65 is attached to the lower part of the outer cylinder 52 to face the opening 52B. The bottom cap 53 is provided with, for example, a mounting eye 53A that is mounted on the wheel of the vehicle.

An inner cylinder 54 is provided in the outer cylinder 52 coaxially with the outer cylinder 52. The lower end of the inner cylinder 54 is fitted to the bottom valve 10. The upper end of the inner cylinder 54 is fitted to the rod guide 7. The inner cylinder 54 (and the outer cylinder 52) serving as a cylinder is sealed with an oil liquid as a hydraulic fluid (working fluid). The oil liquid, which is the hydraulic fluid, is not limited to oil, and may be, for example, water mixed with an additive.

The inner cylinder 54 forms (defines) an annular reservoir chamber A between itself and the outer cylinder 52. That is, the reservoir chamber A is provided between the inner cylinder 54 and the outer cylinder 52. Gas is sealed in the reservoir chamber A together with oil liquid, which is a working liquid. The gas may be, for example, air at atmospheric pressure, or a gas such as compressed nitrogen gas. The reservoir chamber A compensates for the entry and exit of the piston rod 9. An oil hole 54A is formed in the radial direction of the inner cylinder 54 at a midway position in the longitudinal direction (axial direction) so that the rod-side oil chamber C always communicates with the annular oil chamber F.

The piston 4 is slidably fitted in the inner cylinder 54. That is, the piston 4 is slidably provided within the inner cylinder 54. The piston 4 divides (defines, separates) the interior of the inner cylinder 54 into two chambers (i.e., the bottom-side oil chamber B as one side chamber and the rod-side oil chamber C as the other side chamber). The piston 4 is connected to the piston rod 9. The piston 4 is provided with a plurality of oil passages 4A and 4B that are spaced apart in the circumferential direction to allow the rod-side oil chamber C and the bottom-side oil chamber B to communicate with each other.

The extension-side disk valve 55 is provided on the lower end surface of the piston 4. When the piston 4 is slidably displaced upward in the extension stroke (elongation stroke) of the piston rod 9, the extension-side disk valve 55 opens when the pressure in the rod-side oil chamber C exceeds a relief set pressure, and relieves the pressure at this time to the bottom-side oil chamber B through each oil passage 4B. The relief set pressure is set, for example, to a pressure higher than the valve opening pressure when the damping force adjusting device 65 is set to a hard state.

On the upper end face of the piston 4, a contraction-side check valve 56 is provided to open when the piston 4 is slidably displaced downward in the contraction stroke (compression stroke) of the piston rod 9, and to close at other times. The check valve 56 allows the oil liquid in the bottom-side oil chamber B to flow through each oil passage 4A toward the rod-side oil chamber C, and suppresses the oil liquid from flowing in the opposite direction. The valve opening pressure of the check valve 56 is set to, for example, a pressure lower than the valve opening pressure when the damping force adjusting device 65 is set to a soft state, and substantially no damping force is generated. The substantially no damping force is, for example, a force equal to or less than the friction of the piston 4 and the rod seal 8, and does not affect the movement of the vehicle.

A piston rod 9 serving as a rod extends axially within the inner cylinder 54. A lower end of the piston rod 9 is inserted into the inner cylinder 54. The piston rod 9 is fixed to the piston 4 with a nut 57. The upper end of the piston rod 9 protrudes outside the outer cylinder 52 and the inner cylinder 54 via the rod guide 7. That is, the piston rod 9 is connected to the piston 4 and extends outside the inner cylinder 54.

A stepped cylindrical rod guide 7 is provided on the upper end of the inner cylinder 54. The rod guide 7 positions the upper portion of the inner cylinder 54 at the center of the outer cylinder 52 and guides the piston rod 9 axially slidably on the inner periphery thereof. An annular rod seal 8 is provided between the rod guide 7 and the caulked portion 52A of the outer cylinder 52. The rod seal 8 is constructed, for example, by baking an elastic material such as rubber onto a metal annular plate having a hole through which the piston rod 9 is inserted. The rod seal 8 seals with the piston rod 9 by slidingly contacting the inner periphery of the elastic material with the outer periphery of the piston rod 9.

The rod seal 8 is formed with a lip seal 58 as a check valve that extends to contact the rod guide 7 on the lower surface. The lip seal 58 is arranged between the oil reservoir chamber 59 and the reservoir chamber A. The lip seal 58 allows the oil liquid in the oil reservoir chamber 59 to flow toward the reservoir chamber A through a return passage 60 of the rod guide 7 and suppresses the reverse flow.

An intermediate cylinder 61 is arranged as a separator tube between the outer cylinder 52 and the inner cylinder 54. The intermediate cylinder 61 is attached to, for example, the outer periphery of the inner cylinder 54 via upper and lower cylindrical seals 62 and 62. The intermediate cylinder 61 surrounds the entire outer circumference of the inner cylinder 54 and extends in the axial direction. The intermediate cylinder 61 forms an axially extending annular oil chamber F between itself and the inner cylinder 54. The annular oil chamber F is an oil chamber independent of the reservoir chamber A. The annular oil chamber F is always communicated with the rod-side oil chamber B through an oil hole 54A formed radially in the inner cylinder 54. A connection port 61A to which a cylindrical holder 68 of a damping force adjusting valve 66 is attached is provided on the lower end of the intermediate cylinder 61.

The bottom valve 10 is positioned on the lower end of the inner cylinder 54 and provided between the bottom cap 53 and the inner cylinder 54. The bottom valve 10 includes a valve body 11 that divides (defines, separates) the reservoir chamber A and the bottom-side oil chamber B between the bottom cap 53 and the inner cylinder 54, a contraction-side disk valve 63 provided on the lower surface of the valve body 11, and an extension-side check valve 13 provided on the upper surface of the valve body 11. The valve body 11 is formed with oil passages 11A and 11B that allow the reservoir chamber A and the bottom-side oil chamber B to communicate with each other in the circumferential direction.

When the piston 4 is slidably displaced upward in the contraction stroke of the piston rod 9, the contraction-side disk valve 63 opens when the pressure in the bottom-side oil chamber C exceeds a relief set pressure, and relieves the pressure oil (pressure) at this time to the reservoir chamber A through each oil passage 11A. The relief set pressure is set, for example, to a pressure higher than the valve opening pressure when the damping force adjusting device 65 is set to a hard state.

The extension-side check valve 13 opens when the piston 4 is slidably displaced upward during the extension stroke of the piston rod 9, and closes at other times. The check valve 13 allows the oil liquid in the reservoir chamber A to flow through each oil passage 11B toward the bottom-side oil chamber C, and suppresses the oil liquid from flowing in the opposite direction. The valve opening pressure of the check valve 13 is set to, for example, a pressure lower than the valve opening pressure when the damping force adjusting device 65 is set to a soft state, and substantially no damping force is generated.

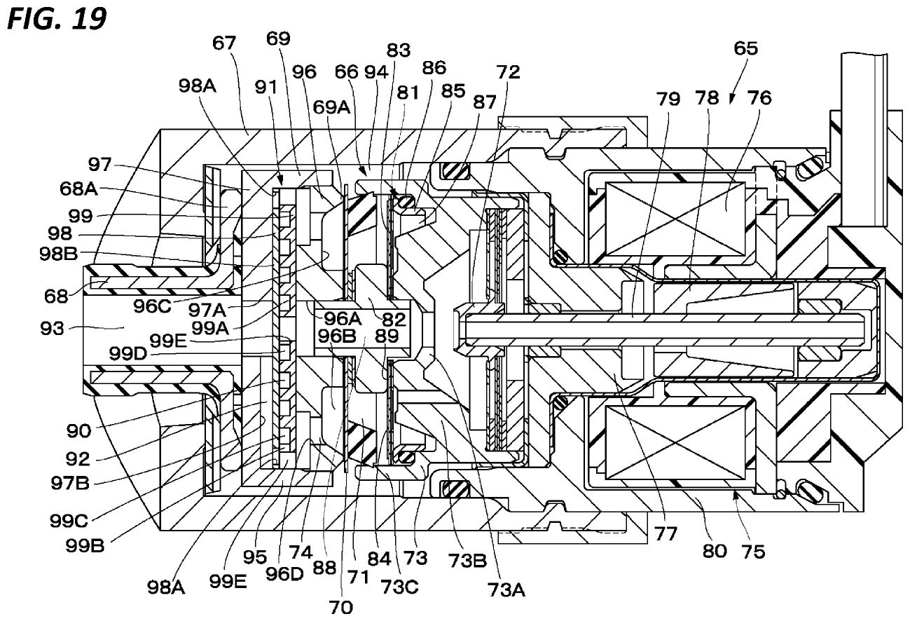

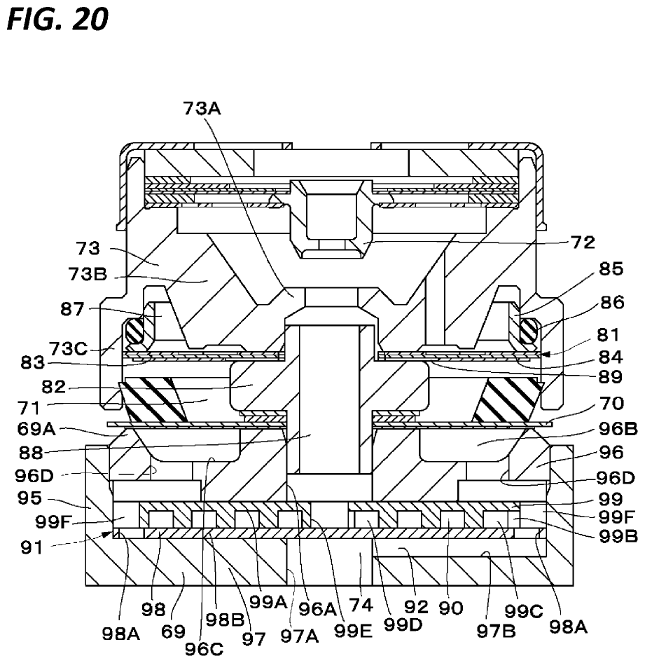

Next, descriptions will be made on the damping force adjusting device 65 for variably adjusting the damping force generated by the shock absorber 51. FIG. 20 is labeled with the right sides of FIGS. 18 and 19 facing upward. FIGS. 18 and 19 correspond to the vertical direction in FIG. 20.

As illustrated in FIG. 18, the damping force adjusting device 65 has a base end (i.e., the left end in FIG. 18) arranged between the reservoir chamber A and the annular oil chamber F, and is provided so that the tip end thereof (i.e., the right end in FIG. 18) protrudes radially outward from the lower portion of the outer cylinder 52. The damping force adjusting device 65 controls the flow of pressure oil (oil liquid) flowing from the annular oil chamber F in the intermediate cylinder 61 to the reservoir chamber A by a damping force adjusting valve 66 to variably adjust the damping force generated at this time. That is, the damping force adjusting valve 66 is variably controlled in the generated damping force by adjusting the valve opening pressure of a set pressure variable valve 70 (to be described later) with a damping force variable actuator (solenoid 75). The damping force adjusting device 65 controls the flow of working fluid (oil liquid) caused by the sliding of the piston 4 inside the inner cylinder 54 to generate a damping force.

The damping force adjusting valve 66 serving as a damping force adjusting mechanism includes a valve case 67 having a base end fixed around the opening 52B of the outer cylinder 52 and a tip end protruding radially outward from the outer cylinder 52, a cylindrical holder 68 having a base end fixed to the connection port 61A of the intermediate cylinder 61 and a tip end being an annular flange portion 68A and arranged inside the valve case 67 with a gap, a valve member 69 arranged in the valve case 67 and in contact with the flange portion 68A of the cylindrical holder 68, a set pressure variable valve 70 consisting of a main disk valve that seats and disengages an annular valve seat 69A of the valve member 69, a pilot chamber 71 that serves as a back pressure chamber for applying back pressure to the set pressure variable valve 70, a pilot valve member 72 that variably sets a pilot pressure (back pressure) in the pilot chamber 71 according to the energization (current value) of the solenoid 75 and adjusts the valve opening pressure of the set pressure variable valve 70, and a pilot body 73 on which the pilot valve member 72 is seated and disengaged.

The set pressure variable valve 70 receives pressure in the direction of seating on the annular valve seat 69A of the valve member 69 (i.e., in the valve closing direction) by the pilot pressure (back pressure) from the pilot chamber 71. That is, the set pressure variable valve 70 receives the pressure on the inlet (i.e., the annular oil chamber F) of the cylindrical holder 68, and when the pressure exceeds the pilot pressure (back pressure) of the pilot chamber 71 and the valve opening pressure due to the rigidity of the main disk valve, leaves the annular valve seat 69A of the valve member 69 to open.

In this case, the valve opening pressure of the set pressure variable valve 70 is variably set by adjusting the pilot pressure (back pressure) in the pilot chamber 71 via the pilot valve member 72. When the set pressure variable valve 70 leaves (opens) the annular valve seat 69A of the valve member 69, the pressure oil from the annular oil chamber F (i.e., the intermediate cylinder 61) flows out of the set pressure variable valve 70 through a first passage 74 in the valve member 69, and flows from between the flange portion 68A of the cylindrical holder 68 and the valve case 67 to the reservoir chamber A through the opening 52B of the outer cylinder 52.

The first passage 74 in the valve member 69 is a passage through which the working fluid flows from the rod-side oil chamber C (i.e., the annular oil chamber F) in the inner cylinder 54 to the reservoir chamber A as the piston 4 moves. The set pressure variable valve 70 is a main valve that is provided in the first passage 74 and controls the flow of working fluid to generate a damping force. The pilot chamber 71 is a back pressure chamber that applies pressure in the valve closing direction to the set pressure variable valve 70, which is the main valve.

A solenoid 75 serving as an actuator constitutes a damping force adjusting device 65 together with a damping force adjusting valve 66 and is used as a damping force variable actuator. As illustrated in FIG. 19, the solenoid 75 includes a cylindrical coil 76 that generates a magnetic force when energized from the outside, a stator core 77 that is arranged on the inner periphery of the coil 76, a plunger 78 as a movable iron core provided movably in the axial direction on the inner periphery of the stator core 77, an operating pin 79 integrally provided on the center of the plunger 78, and a cover member 80 that covers the outer periphery of the coil 76.

The cover member 80 constitutes a yoke made of a magnetic material and forms a magnetic circuit on the outer periphery of the coil 76. The operating pin 79 extends through the plunger 78 in the axial direction (see the horizontal direction in FIG. 19), and the pilot valve member 72 of the damping force adjusting valve 66 is fixed to the left projecting end. That is, the operating pin 79 of the solenoid 75 is fitted inside the pilot valve member 72. The pilot valve member 72 is displaced horizontally (leftward and rightward) integrally with the plunger 78 and the operating pin 79.

The plunger 78 of the solenoid 75 generates an axial thrust proportional to the energization (current value) of the coil 76, and the pilot pressure (back pressure) in the pilot chamber 71 is variably set corresponding to the thrust of the plunger 78 by the displacement of the pilot valve member 72. That is, the valve opening pressure of the set pressure variable valve 70 that opens against the pressure in the pilot chamber 71 is adjusted by axially displacing the pilot valve member 72 in accordance with the energization of the solenoid 75. In other words, the valve opening pressure of the set pressure variable valve 70 is increased or decreased by controlling the current value applied to the coil 76 of the solenoid 75 by the controller and displacing the pilot valve member 72 in the axial direction. Therefore, the damping force generated by the shock absorber 51 may be variably adjusted according to the valve opening pressure of the set pressure variable valve 70 which is proportional to the energization (current value) of the solenoid 75.

Next, the frequency response unit 81 will be described.

A pilot body 73 of the damping force adjusting valve 66 incorporates a frequency response unit 81. That is, in the third embodiment, the frequency response unit 81 is provided integrally with the damping force adjusting valve 66. The frequency response unit 81 acts on the pilot chamber 71, which is the back pressure chamber of the damping force adjusting valve 66 (i.e., the set pressure variable valve 70).

A pilot pin 82 is sandwiched between the pilot body 73 and the valve member 69. The pilot pin 82 sandwiches the set pressure variable valve 70 with the valve member 69. The pilot body 73 includes a valve seat portion 73A on which the pilot valve member 72 is seated and disengaged, an annular plate portion 73B that bends from the valve seat portion 73A toward the pilot valve member 72 and widens radially outward, and a cylindrical portion 73C axially extending from the outer diameter side of the annular plate portion 73B toward the set pressure variable valve 70. A free valve 83 is sandwiched between the pilot pin 82 and the pilot body 73 to reduce a damping force against radio-frequency vibrations.

The free valve 83 includes, for example, a plurality of (e.g., three) disks 84, a retainer 85 located on the outer diameter side of the disk 84 and provided on the side opposite to the pilot chamber 71, and an O-ring 86 that seals the retainer 85 and the inner peripheral surface of the cylindrical portion 73C of the pilot body 73 and presses the disk 84 toward the pilot chamber 71 via the retainer 85. The disk 84 is provided movably with respect to the pilot body 73 (cylindrical portion 73C) that forms the pilot chamber 71. The disk 84 divides the inside of the cylindrical portion 73C of the pilot body 73 into the pilot chamber 71 and the variable chamber 87. The disk 84 changes the volume of the pilot chamber 71.

The disk 84 is provided with a communication orifice 89 that connects an oil passage 88 in the pilot pin 82 and the pilot chamber 71. The O-ring 86 is provided opposite to the pilot chamber 71 with respect to the disk 84. The O-ring 86 seals the outer periphery of the disk 84 and the inner periphery of the cylindrical portion 73C of the pilot body 73. In this case, the O-ring 86 functions as a spring member that biases the disk 84 and as a sealing member that seals the pilot chamber 71 by applying a surface pressure to the inner periphery of the cylindrical portion 73C of the pilot body 73 and the outer periphery of the retainer 85. The free valve 83 is relatively displaced to move or stop within the cylindrical portion 73C of the pilot body 73 according to the vibration frequency of the piston rod 9 and/or the inner cylinder 54. Thus, the free valve 83 operates as a frequency response valve that adjusts the internal pressure of the pilot chamber 71 according to the frequency.

That is, when a radio-frequency fine amplitude is input, a pressure acts on the pilot chamber 71 through the communication orifice 89, thereby causing the disk 84 to bend and the volume of the pilot chamber 71 to increase. Thus, the pressure in the pilot chamber 71 is lowered and the set pressure variable valve 70 is easily opened, thereby keeping the damping force low. Meanwhile, when a low-frequency large amplitude input is applied to the pilot chamber 71 through the communication orifice 89, the disk 84 is bent and the O-ring 86 is compressed. Thus, the force acting on the disk 84 increases, and the disk 84 becomes less flexible, thereby stopping the pressure drop in the pilot chamber 71. As a result, the set pressure variable valve 70 becomes difficult to open, and the damping force maintains high characteristics.

In this way, the free valve 83, which is a frequency response valve, may reduce the damping force with respect to the radio-frequency input and improve the transmission characteristics of vibration. However, since the volume of the pilot chamber 71 is changed by the disk 84, the retainer 85, and the O-ring 86 which are movable portions, the free valve 83, which is a frequency response valve, tends to cause a delay (phase delay) in the reduction of damping force at radio frequencies. This may lower the effectiveness of damping force reduction in reducing vibration transmission. Therefore, in the third embodiment, a flow passage forming member 91 that forms a phase correction communication passage 90 is provided, and the delay is corrected (the phase is corrected) by the oil inertial force in the phase correction communication passage 90. That is, in the third embodiment, the delay (phase delay) at the time of radio-frequency input is improved by combining the free valve 83 serving as a frequency response valve with the phase correction communication passage 90. As a result, the effect of reducing the damping force due to frequency response may be sufficiently obtained as the effect of reducing the transmission of vibration.

That is, in the third embodiment, the shock absorber 51 includes a cylinder-side member having an inner cylinder 54, a piston-side member having a piston 4 and a piston rod 9, a damping force adjusting valve 66 whose opening/closing operation is adjusted by a solenoid 75, and a frequency response unit 81 having a free valve 83 as a moving member that may be moved by the working fluid of the rod-side oil chamber C, which is the other side chamber. Further, in the third embodiment, the damping force adjusting valve 66 is provided with the frequency response unit 81 and the phase correction communication passage 90. Specifically, the valve member 69 of the damping force adjusting valve 66 is assembled with a flow passage forming member 91 that forms a phase correction communication passage 90. Thus, the flow passage forming member 91 is provided between the rod-side oil chamber C and the reservoir chamber A, which are the other side chambers. That is, the flow passage forming member 91 is provided in an oil passage 92 that connects the rod-side oil chamber C and the reservoir chamber A. The oil passage 92 is an oil passage located between an oil passage 93 (see, e.g., FIG. 19) in the cylindrical holder 68 connected to the annular oil chamber F (i.e., the rod-side oil chamber C) and an oil passage 94 in the valve case 67 connected to the reservoir chamber A (see, e.g., FIG. 19). That is, the oil passage 92 corresponds to a third communication passage that communicates the rod-side oil chamber C (other side chamber) and the reservoir chamber A with each other. The oil passage 92 is a flow passage through which the oil liquid (working fluid) flows as the piston 4 moves.

The valve member 69 of the damping force adjusting valve 66 includes a bottomed cylindrical member 95 as a first member and a disk-shaped cover member 96 as a second member. The flow passage forming member 91 is provided between the cylindrical member 95 and the cover member 96. That is, the valve member 69 (i.e., the cylindrical member 95 and the cover member 96) corresponds to a storage member that stores the flow passage forming member 91. A bottom portion 97 of the cylindrical member 95 is provided with a center hole 97A and an introduction groove 97B extending radially outward from the center hole 97A. The cover member 96 is provided with a center hole 96A to which the pilot pin 82 is connected, an annular valve seat 69A on which the set pressure variable valve 70 is seated and disengaged, an annular concave portion 96C that forms an annular oil chamber 96B that is opened and closed by the set pressure variable valve 70, and a through hole 96D that opens into the annular concave portion 96C.

The flow passage forming member 91 forms a phase correction communication passage 90 that is a swirling-shaped throttle path (orifice portion) by stacking two disks 98 and 99. That is, the flow passage forming member 91 includes an introduction disk 98 and a passage disk 99 which are stacked to form a phase correction communication passage 90. The flow passage forming member 91, that is, the introduction disk 98 and the passage disk 99 are sandwiched between the cylindrical member 95 and the cover member 96 of the valve member 69.

The introduction disk 98 includes a through groove 98A extending in the circumferential direction and a closing portion 98B that closes the opening of a bottomed groove 99A of the passage disk 99. That is, three through grooves 98A extending in the circumferential direction are formed on the outer diameter side of the introduction disk 98, and a portion separated from the through grooves 98A serves as a closing portion 98B. Meanwhile, the passage disk 99 has a swirling-shaped bottomed groove 99A extending in the circumferential direction. Specifically, the passage disk 99 is provided with a lateral groove 99B that serves as an introduction port at a position corresponding to the through groove 98A of the introduction disk 98. The passage disk 99 has a bottomed groove 99A that starts from the lateral groove 99B and spirals radially inward while extending in the circumferential direction from the lateral groove 99B.

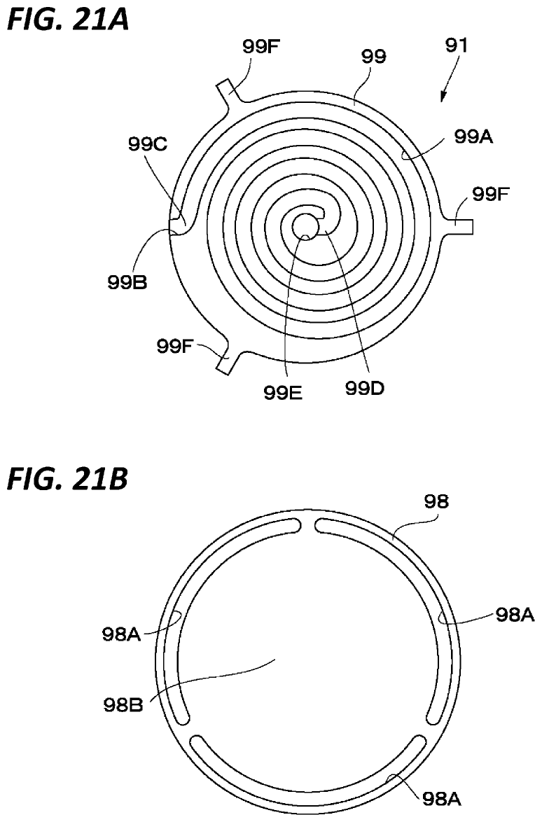

In this case, as illustrated in FIGS. 21A and 21B, the bottomed groove 99A extends from an outer diameter side end 99C positioned radially outwardly of the passage disk 99 to an inner diameter side end 99D positioned most radially inwardly, for three and a half turns, that is, 1260° circumferentially (clockwise). A through hole 99E is provided at the inner diameter side end 99D, that is, at the center of the passage disk 99. An opening of the bottomed groove 99A of the passage disk 99 is blocked by the closing portion 98B of the introduction disk 98, thereby forming a spirally extending phase correction communication passage 90. Further, on the outer diameter side of the passage disk 99, protrusions 99F having a length approximately equal to the groove width of the through groove 98A of the introduction disk 98 are provided at a plurality of positions (three positions) spaced at equal intervals in the circumferential direction. As a result, a radial gap (oil passage space) is formed between the cylindrical member 95 and the passage disk 99, and the oil liquid that has passed through the through groove 98A of the introduction disk 98 is introduced into the bottomed groove 99A through the lateral groove 99B of the passage disk 99. The oil liquid that has passed through the through groove 98A is also introduced into the annular oil chamber 96B.

The cross section of the bottomed groove 99A may be, for example, rectangular as illustrated in FIG. 20. However, the present disclosure is not limited thereto. Although not illustrated in the drawings, various bottomed grooves, such as, for example, a bottomed groove having a trapezoidal cross section whose side surface is inclined so that the width of the groove decreases toward the bottom portion, a bottomed groove having a U-shaped cross section with an arc-shaped bottom portion, and a bottomed groove having a semi-arc cross section, may be adopted. As illustrated in FIG. 20, the flow passage forming member 91 is constructed by stacking a passage disk 99 and an introduction disk 98 in order from the cover member 96 of the valve member 69. As a result, on the inner cylinder 54 rather than the communication orifice 89 serving as the introduction passage for introducing the working fluid into the pilot chamber 71, a phase correction communication passage 90 is formed as a swirling flow passage that continuously (several times) turns while changing the distance from the center on the same plane. The orbiting circumference of the phase correction communication passage 90, in other words, the length of the phase correction communication passage 90 (the length of the bottomed groove 99A) may be appropriately adjusted to obtain the required damping force delay correction effect. Also, the shape of the cross-sectional area of the bottomed groove 99A and the number of the passage disks 99 may be adjusted as required.

Thus, in the third embodiment, the phase correction communication passage 90 is formed by the flow passage forming member 91 (more specifically, the swirling bottomed groove 99A of the passage disk 99). The phase correction communication passage 90 is provided in an oil passage 92 between the rod-side oil chamber C, which are the other side chamber, and the reservoir chamber A. That is, the phase correction communication passage 90 is provided in the oil passage 92 which is a communication passage (third communication passage) through which the working fluid (oil liquid) flows due to the movement of the piston 4. A third damping mechanism is provided in the phase correction communication passage 90. In this case, the third damping mechanism is configured as a phase correction unit that advances the phase of the damping force by the inertial force of the working fluid in the phase correction communication passage 90. That is, the phase correction communicating passage 90 is configured as a damping mechanism that generates a force (axial force) that advances the phase of the damping force in addition to generating the damping force as an orifice by including a swirling bottomed groove 99A that continuously (several times) turns while changing the distance from the center on the same plane.

The shock absorber 51 according to the third embodiment has the structure as described above, and the operation thereof will be described below.

When the shock absorber 51 is mounted on a vehicle such as an automobile, for example, the upper end of the piston rod 9 is attached to the vehicle body of the vehicle, and the mounting eye 53A provided on the bottom cap 53 is attached to the wheel. Also, the solenoid 75 is connected to a vehicle controller. When vibrations occur in the vertical direction due to unevenness of the road surface while the vehicle is running, the piston rod 9 may be displaced to extend or contract from the outer cylinder 52, and a damping force may be generated by the damping force adjusting device 65, thereby damping the vibration of the vehicle. At this time, by controlling the current value to the coil 76 of the solenoid 75 by the controller and adjusting the valve opening pressure of the pilot valve member 72, the damping force generated by the shock absorber 51 may be variably adjusted.

For example, during the extension stroke of the piston rod 9, the movement of the piston 4 within the inner cylinder 54 causes the compression-side check valve 56 of the piston 4 to close. Before the disk valve 55 of the piston 4 opens, the oil liquid in the rod-side oil chamber C is pressurized and flows into the damping force adjusting valve 66 through the oil hole 54A of the inner cylinder 54, the annular oil chamber F, and the connection port 61A of the intermediate cylinder 61. At this time, the amount of oil liquid caused by the movement of the piston 4 flows from the reservoir chamber A into the bottom-side oil chamber B by opening the extension-side check valve 13 of the bottom valve 10. When the pressure in the rod-side oil chamber C reaches the valve opening pressure of the disk valve 55, the disk valve 55 opens to relieve the pressure in the rod-side oil chamber C to the bottom-side oil chamber B.

During the compression stroke of the piston rod 9, the movement of the piston 4 in the inner cylinder 54 opens the compression-side check valve 56 of the piston 4 and closes the extension-side check valve 13 of the bottom valve 10. The oil liquid in the bottom-side oil chamber B flows into the rod-side oil chamber C before the bottom valve 10 (disk valve 63) is opened. Also, the amount of oil liquid corresponding to the amount of the piston rod 9 that has penetrated into the inner cylinder 54 flows from the rod-side oil chamber C into the damping force adjusting valve 66. At this time, when the pressure in the bottom-side oil chamber B reaches the valve opening pressure of the bottom valve 10 (disk valve 63), the bottom valve 10 (disk valve 63) opens, and the pressure in the bottom-side oil chamber B is relieved to the reservoir chamber A.

During both the extension stroke and the contraction stroke of the piston rod 9, the pressure oil in the rod-side oil chamber C flows from the inner cylinder 54 into the annular oil chamber F through the oil hole 54A as the piston 4 is displaced, and the pressure oil in the annular oil chamber F flows to the damping force adjusting device 65 through the connection port 61A of the intermediate cylinder 61. At this time, in the damping force adjusting device 65, before the set pressure variable valve 70 of the damping force adjusting valve 66 is opened, a damping force is generated by the valve opening pressure of the pilot valve member 72. After the set pressure variable valve 70 is opened, a damping force is generated according to the opening degree of the set pressure variable valve 70. In this case, the damping force may be controlled by adjusting the valve opening pressure of the pilot valve member 72 by energizing the coil 76 of the solenoid 75.

That is, when the thrust force of the plunger 78 is reduced by decreasing the current supplied to the coil 76, the valve opening pressure of the pilot valve member 72 is decreased and the damping force on the soft side is generated. Meanwhile, when the thrust force of the plunger 78 is increased by increasing the current supplied to the coil 76, the valve opening pressure of the pilot valve member 72 is increased, and the damping force on the hard side is generated. At this time, the internal pressure of the pilot chamber 71 communicated through the communication orifice 89 on the upstream side changes depending on the valve opening pressure of the pilot valve member 72. Accordingly, by controlling the valve opening pressure of the pilot valve member 72, the valve opening pressure of the set pressure variable valve 70 may be adjusted at the same time, and the adjustment range of the damping force characteristic may be widened.

Further, when a radio-frequency fine amplitude is input, pressure acts on the pilot chamber 71 through the communication orifice 89 of the disk 84, thereby bending the disk 84 and increasing the volume of the pilot chamber 71. Thus, the pressure in the pilot chamber 71 is lowered and the set pressure variable valve 70 is easily opened, thereby keeping the damping force low. At this time, the delay (phase delay) of the movable portion (disk 84) of the frequency response unit 81 is corrected by the oil inertial force of the phase correction communication passage 90 formed by the flow passage forming member 91. When a low-frequency large amplitude input is applied to the pilot chamber 71 through the communication orifice 89 of the disk 84, the disk 84 bends and the O-ring 86 is compressed. Thus, the force acting on the disk 84 increases, and the disk 84 becomes less flexible, thereby stopping the pressure drop in the pilot chamber 71. As a result, the set pressure variable valve 70 becomes difficult to open, and the damping force maintains high characteristics.

In the third embodiment, the valve member 69 of the damping force adjusting valve 66 incorporates the flow passage forming member 91 forming the phase correction communication passage 90 as described above. There is no particular difference in its basic action from those of the above-described first embodiment, second embodiment, and modification.

That is, in the third embodiment, the phase of the damping force may be advanced by the phase correction communication passage 90, which is the phase correction unit. As a result, for example, with respect to radio-frequency vibration, the pressure of the acceleration phase due to the inertial force (oil inertial force) of the working fluid in the phase correction communication passage 90 may be applied to the working chamber. As a result, the damping force phase delayed with respect to the piston speed phase may be advanced, the damping force in the damping region for the sprung mass of the vehicle may be increased, and the damping force in the excitation region may be reduced. Therefore, it is possible to reduce vibration damping and vibration transmission on the sprung mass of the vehicle, and improve riding comfort with respect to the radio-frequency input. That is, the phase delay of the damping force at the time of radio-frequency input may be improved by the inertial force of the oil in the phase correction communication passage 90.

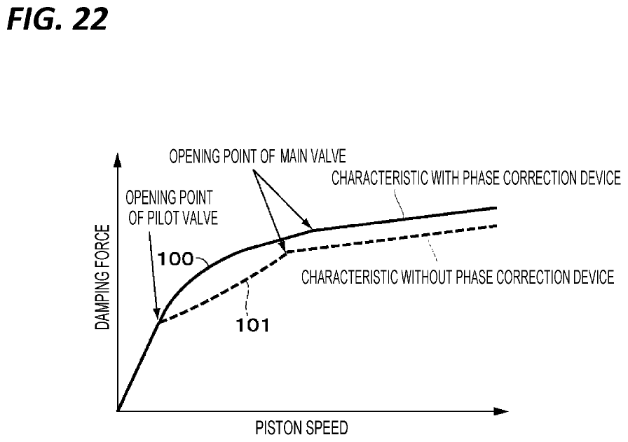

FIG. 22 illustrates a relationship between a piston speed and a damping force. In FIG. 22, a solid line 100 indicates the damping force characteristic of a damping force adjustable shock absorber 51 that includes a phase correction device (phase correction communication passage 90). A dashed line 101 indicates the damping force characteristic of a damping force adjustable shock absorber according to a comparative example that does not include a phase correction device (phase correction communication passage 90) (i.e., has a normal constant orifice).

In the third embodiment, the pilot orifice portion of the damping force adjusting mechanism (damping force adjusting valve) is configured by a phase correction communication passage 90 that is a swirling flow passage. In this case, the equivalent orifice diameter of the pilot orifice gradually changes due to the characteristic difference illustrated in FIG. 10 described above. Therefore, as indicated by the solid line 100 in FIG. 22, the damping force changes smoothly after the pilot valve member 72 (pilot valve) opens until the set pressure variable valve 70 (main valve) opens. In particular, in the hard damping force characteristics, it is possible to reduce chattering when the valve is opened, which is a problem with pilot valve type control valves. Therefore, the sound and vibration performance may be improved, and the change in damping force may be smoothed, so that riding comfort may be improved by reducing the jerk.

That is, in the third embodiment, since the damping force adjusting valve 66 whose opening/closing operation is adjusted by the solenoid 75 is provided, the damping force may be variably adjusted by the damping force adjusting valve 66. Further, since the frequency response unit 81 having the disk 84 movable by the working fluid is provided, the frequency response unit 81 may reduce the damping force at the time of radio-frequency vibration. Even when the damping force adjusting mechanism does not perform a control for compensating for the response delay, the phase correction communication passages 15 and 90 may suppress the phase delay caused by the damping force adjusting valve 66 and the frequency response unit 81, which are movable portions. Therefore, it is possible to further improve the riding comfort.

In this case, the phase correction communication passage 90, which is a swirling flow passage, is provided closer to the inner cylinder 54 than the communication orifice 89, which is an introduction passage for introducing the working fluid into the pilot chamber 71 of the set pressure variable valve 70. Therefore, the delay in the damping force (phase delay) that is generated when the damping force is reduced due to the effect of the frequency response unit 81 with respect to the radio-frequency input may be corrected by the inertial force of the oil in the phase correction communication passage 90. That is, although the damping force for radio-frequency input may be reduced by providing the frequency response unit 81, the phase delay with respect to the speed phase tends to increase as it is. Therefore, by combining the phase correction communication passage 90, the radio-frequency phase delay may be improved, and the vibration transmission of the radio-frequency input may be further reduced. This makes it possible to improve riding comfort. As illustrated in FIG. 22, the pressure change at the opening point of the damping force adjusting valve 66 (i.e., the set pressure variable valve 70) may be reduced, and the sound and vibration performance may be improved. Further, since the damping force adjusting valve 66 is provided with the frequency response unit 81 and the phase correction passage 90, the phase correction passage 90 and the frequency response unit 81 may be integrally handled together with the damping force adjusting valve 66.

In the third embodiment, as an example, descriptions have been made on the configuration in which the passage disk 99 of the passage forming member 91 forming the phase correction communicating passage 90 has the bottomed groove 99A. However, without being limited thereto, for example, the bottomed groove of the passage disk may be used as the through groove. In this case, as required, a separate closing disk may be provided to close the through groove.

In the third embodiment, as an example, descriptions have been made on the case where the set pressure variable valve 70 serving as the main valve is provided in the first passage 74 through which the working fluid flows from the rod-side oil chamber C (i.e., the other side chamber) to the reservoir chamber A. However, the present disclosure is not limited thereto, and, for example, the main valve may be provided in a passage through which the working fluid flows from the bottom-side oil chamber (i.e., the one side chamber) to the reservoir chamber.

In the third embodiment, as an example, descriptions have been made on the case where the frequency response unit 81 acting on the pilot chamber 71 of the damping force adjusting valve 66 (i.e., the set pressure variable valve 70) is provided. However, without being limited thereto, for example, instead of providing the damping force adjusting valve 66 with the frequency response unit 81, the piston rod 9 may be provided with the frequency response unit 32 as illustrated in FIG. 14. Further, the frequency response unit may be omitted and the configuration may be adopted in which a phase correction communication passage (phase correction unit) is provided in the damping force adjustable shock absorber (i.e., a phase correction communication passage is provided without providing a frequency response unit in the damping force adjusting valve). Also, the damping force adjusting valve may be omitted.

In the first embodiment, a dual-tube shock absorber 1 including the outer cylinder 2 and the inner cylinder 3 has been described as an example. However, the present disclosure is not limited thereto, and may be applied to, for example, a shock absorber including a single-tube cylindrical member (cylinder). This also applies to other embodiments and modification.

Further, in each of the embodiments and modification, a shock absorber attached to an automobile has been described as a representative example of the shock absorber. However, the present disclosure is not limited thereto, and may be applied to, for example, shock absorbers attached to railway vehicles. In addition, the present disclosure may be applied not only to vehicles such as automobiles and railroad vehicles, but also to various shock absorbers used in various machines, structures, and buildings which serve as vibration sources. The respective embodiments and modification are examples, and there is no need to say that partial replacement or combination of configurations represented in different embodiments and modification are possible.

As shock absorbers based on the embodiments described above, for example, the following aspects are conceivable.

According to a first aspect of the present disclosure, a shock absorber includes: a cylinder-side member including a cylinder in which a working fluid is sealed; a piston-side member including a piston that divides an inside of the cylinder into one side chamber and the other side chamber, and a piston rod that is connected to the piston and extends to an outside of the cylinder; a first communication passage provided on the piston-side member and communicating the one side chamber and the other side chamber; a second communication passage provided on the cylinder-side member and communicating the one side chamber and the other side chamber; and a first damping mechanism and a second damping mechanism provided in the first communication passage and the second communication passages, respectively. The second damping mechanism is a phase correction unit that advances a phase of a damping force by an inertial force of the working fluid in the second communication passage.

According to the first aspect, the phase of the damping force may be advanced by the second damping mechanism, which is the phase correction unit. In this case, the second damping mechanism (phase correction member) makes, for example, the length of the second communication passage (passage length) larger than the cross-sectional area (e.g., 30≤passage length l/cross-sectional area≤1200 [l/mm]). Thus, for example, with respect to radio-frequency vibration, the pressure of the acceleration phase due to the inertial force (oil inertial force) of the working fluid in the second communication passage may be applied to one side chamber or the other side chamber that becomes the working chamber (piston upper and lower chambers) of the cylinder. As a result, the damping force phase may be advanced with respect to the piston speed phase, the damping force in the damping region for the sprung mass (body) of the vehicle may be increased, and the damping force in the excitation region may be reduced. Therefore, it is possible to reduce vibration damping and vibration transmission on the sprung mass of the vehicle, and improve riding comfort with respect to the radio-frequency input. In this case, for example, by appropriately adjusting the length of the second communication passage that serves as the second damping mechanism (phase correction member), the damping force phase may be matched with the piston speed phase near the unsprung resonance frequency. As a result, the unsprung vibration may be appropriately damped by the damping force of the shock absorber (damper), and the rattling of the unsprung mass may be suppressed to improve the riding comfort (improve the wobbly feeling).

As a second aspect of the present disclosure, in the first aspect, the cylinder-side member includes a rod guide that is provided in an opening of the cylinder and guides the piston rod, and the second damping mechanism is provided on the rod guide. According to the second aspect, since the second damping mechanism, which is the phase correction unit, is provided in the rod guide, the second communication passage that generates the inertial force of the working fluid (oil inertial force) may be configured by stacking, for example, disks. Therefore, for example, the length of the second communication passage may be adjusted according to the number of disks. Accordingly, it is possible to easily adjust the inertial force of the working fluid in the second communication passage as desired, that is, match the inertial force with the desired damping force characteristic.

As a third aspect of the present disclosure, in the first aspect, an outer cylinder is formed on an outer periphery of the cylinder, a reservoir chamber is provided between the cylinder and the outer cylinder to compensate for an entry and exit of the piston rod, and the second damping mechanism is provided in the reservoir chamber. According to the third aspect, since the second damping mechanism, which is the phase correction unit, is provided in the reservoir chamber, the second communication passage that generates the inertial force of the working fluid (oil inertial force) may be configured by, for example, a spiral pipeline that goes around the outer periphery of the cylinder. Therefore, by arranging the spiral pipeline at, for example, the liquid level position (oil level position) of the reservoir chamber, it is possible to suppress the oil level from jumping when the shock absorber operates at high speed. That is, the spiral conduit plays a role of a baffle structure that suppresses jumping of the oil level with respect to changes in the oil level when the shock absorber strokes, thereby suppressing the occurrence of aeration. As a result, lag (missing) in the damping force waveform due to suppression of aeration may be reduced, and damping performance and noise suppression may be achieved.

As a fourth aspect of the present disclosure, in any one of the first to third aspects, a frequency response unit is further provided to include a moving member that is movable by the working fluid of the one side chamber and/or the other side chamber. According to the fourth aspect, the damping force may be reduced at the time of radio-frequency vibration by the frequency response unit. A shock absorber having a frequency response unit has a great effect of reducing the damping force (peak value) of a radio-frequency fine amplitude, but the phase delay tends to increase as the radio-frequency fine amplitude becomes higher. That is, when the frequency response unit 32, which is a movable portion, is provided, the phase delay tends to increase. The second damping mechanism, which is the phase correction unit, may suppress the phase delay, so that the effect of frequency response may be improved. That is, it is possible to improve the phase delay of the radio frequency, further reduce the vibration transmission of the radio-frequency input, and further improve the riding comfort.

As a fifth aspect of the present disclosure, in the fourth aspect, the frequency response unit is provided on the piston rod. According to the fifth aspect, it is possible to suppress the phase delay of the frequency response unit, which is the movable portion provided on the piston rod.

As a sixth aspect of the present disclosure, in any one of the first to fifth aspects, the damping force adjusting mechanism for adjusting the damping force by the actuator is further provided. According to the sixth aspect, the damping force may be variably adjusted by the damping force adjusting mechanism. Further, even when the damping force adjusting mechanism does not perform a control for compensating for the response delay, the phase delay caused by the damping force adjusting mechanism, which is the movable portion, may be suppressed by the second damping mechanism, which is the phase correction unit. Therefore, it is possible to further improve the riding comfort.

According to a seventh aspect of the present disclosure, a shock absorber includes: a cylinder-side member including a cylinder in which a working fluid is sealed; a piston-side member including a piston that divides an inside of the cylinder into one side chamber and the other side chamber, and a piston rod that is connected to the piston and extends to an outside of the cylinder; a reservoir chamber that compensates for an entry and exit of the piston rod; a third communication passage communicating the one side chamber the other side chamber and the reservoir chamber; and a third damping mechanism provided in the third communication passage. The third damping mechanism is a phase correction unit that advances a phase of a damping force by an inertial force of the working fluid in the third communication passage.

According to the seventh aspect, the phase of the damping force may be advanced by the third damping mechanism, which is the phase correction unit. In this case, the third damping mechanism (phase correction member) may make, for example, the length of the third communication passage (passage length) larger than the cross-sectional area (e.g., 30≤passage length l/cross-sectional area a≤1200 [l/mm]). As a result, for example, with respect to radio-frequency vibration, the pressure of the acceleration phase due to the inertial force (oil inertial force) of the working fluid in the third communication passage may be applied to the working chamber. As a result, the damping force phase may be advanced with respect to the piston speed phase, the damping force in the damping region for the sprung mass of the vehicle may be increased, and the damping force in the excitation region may be reduced. Therefore, it is possible to reduce vibration damping and vibration transmission on the sprung mass of the vehicle, and improve riding comfort with respect to the radio-frequency input.

As an eighth aspect of the present disclosure, in the seventh aspect, a damping force adjusting valve whose opening and closing operation is adjusted by a solenoid is further provided, and the damping force adjusting valve is provided with the third damping mechanism. According to the eighth aspect, the damping force may be variably adjusted by the damping force adjusting mechanism. Further, even when the damping force adjusting mechanism does not perform a control for compensating for the response delay, the third damping mechanism, which is the phase correction unit, may suppress the phase delay caused by the damping force adjusting valve, which is the movable portion. Therefore, it is possible to further improve the riding comfort. Since the damping force adjusting valve is provided with the third damping mechanism, the third damping mechanism may be handled integrally with the damping force adjusting valve.

As a ninth aspect of the present disclosure, in the eighth aspect, a frequency response unit including a moving member that is movable by the working fluid of the one side chamber and/or the other side chamber is further provided. The damping force adjusting valve is provided with the third damping mechanism and the frequency response unit. According to the ninth aspect, the damping force may be reduced at the time of radio-frequency vibration by the frequency response unit. Further, even when the damping force adjusting mechanism does not perform a control for compensating for the response delay, the third damping mechanism, which is the phase correction unit, may suppress the phase delay caused by the damping force adjusting valve and the frequency response unit, which are movable portions. Therefore, it is possible to further improve the riding comfort. Since the damping force adjusting valve is provided with the third damping mechanism and the frequency response unit, the third damping mechanism and the frequency response unit may be handled integrally together with the damping force adjusting valve.

### DESCRIPTION OF SYMBOLS

1, 21, 31, 51: shock absorber
2, 52: outer cylinder
3, 54: inner cylinder (cylinder, cylinder-side member)
4: piston (piston-side member)
4A, 4B: oil passage (first communication passage)
5: compression-side valve (first damping mechanism)
6: extension-side valve (first damping mechanism)
9: piston rod (rod)
15, 28: phase correction communication passage (second communication passage, second damping mechanism, phase correction unit)
23: rod guide (cylinder-side member)
32, 81: frequency response unit
33, 83: free valve (moving member)
66: damping force adjusting valve (damping force adjusting mechanism)
75: solenoid (actuator)
90: phase correction communication passage (third damping mechanism, phase correction unit)
92: oil passage (third communication passage)
A: reservoir chamber
B: bottom-side oil chamber (one side chamber)
C: rod-side oil chamber (other side chamber)

1. A shock absorber comprising:
a cylinder including an inner tube in which a working fluid is sealed;
a piston including a piston body that divides an inside of the inner tube into a first chamber and a second chamber, and a piston rod that is connected to the piston body and extends to an outside of the inner tube;
a first communication passage provided on the piston and configured to communicate the first chamber and the second chamber;
a second communication passage provided on the cylinder and configured to communicate the first chamber and the second chamber; and
a first damper and a second damper provided in the first communication passage and the second communication passage, respectively,
wherein the second damper is a phase corrector that advances a phase of a damping force by an inertial force of the working fluid in the second communication passage.

2. The shock absorber according to claim 1, wherein the cylinder includes a rod guide that is provided in an opening of the inner tube and guides the piston rod, and
the second damper is provided on the rod guide.

3. The shock absorber according to claim 1, wherein an outer tube is formed on an outer periphery of the inner tube,
a reservoir chamber is provided between the inner tube and the outer tube to compensate for an entry and exit of the piston rod, and
the second damper is provided in the reservoir chamber.

4. The shock absorber according to claim 1, further comprising: a frequency responder including a mover that is movable by the working fluid of the first chamber and/or the chamber.

5. The shock absorber according to claim 4, wherein the frequency responder is provided on the piston rod.

6. The shock absorber according to claim 1, further comprising: a damping force adjustor configured to adjust a damping force by an actuator.

7. A shock absorber comprising:
a cylinder including an inner tube in which a working fluid is sealed;
a piston including a piston body that divides an inside of the cylinder into a first chamber and a second chamber, and a piston rod that is connected to the piston body and extends to an outside of the inner tube;
a reservoir chamber configured to compensate for an entry and exit of the piston rod;
a communication passage configured to communicate the first chamber or the second chamber and the reservoir chamber; and
a damper provided in the communication passage,
wherein the damper is a phase corrector that advances a phase of a damping force by an inertial force of the working fluid in the communication passage.

8. The shock absorber according to claim 7, further comprising: a damping force adjusting valve whose opening and closing operation is adjusted by a solenoid,
wherein the damping force adjusting valve is provided with the damper.

9. The shock absorber according to claim 8, further comprising: a frequency responder including a mover that is movable by the working fluid of the first chamber and/or the second chamber,
wherein the damping force adjusting valve is provided with the damper and the frequency responder.
